(19) United States
(12) Patent Application Publication
(10) Pub. No.: US 2026/0100803 A1
(43) Pub. Date: Apr. 9, 2026

(54) GLUE REFERENCE SIGNAL FOR MULTIPLE COHERENT DMRS PORTS

(71) Applicant: QUALCOMM Incorporated, San Diego, CA (US)

(72) Inventors: Chih-Hao LIU, San Diego, CA (US); Jing SUN, San Diego, CA (US); Raviteja PATCHAVA, San Diego, CA (US); Somsubhra BARIK, San Diego, CA (US)

(21) Appl. No.: 18/908,423

(22) Filed: Oct. 7, 2024

(51) Int. Cl. H04L 5/00; H04J 13/16; H04W 72/0453

(52) U.S. Cl. CPC H04L 5/0094; H04J 13/16; H04L 5/0007; H04L 5/0048; H04W 72/0453

(57) ABSTRACT

This disclosure provides methods and apparatuses for maintaining phase continuity and optimizing channel estimation in wireless communication systems using multiple coherent demodulation reference signal (DMRS) ports through a glue reference signal (gRS). In various examples, an apparatus for wireless communication such as a UE or network entity may obtain or send, in a first time span, a first reference signal associated with multiple coherent ports in a code division multiplexing (CDM) group; obtain or send, in a second time span prior to the first time span, a second reference signal for compensation of a phase change across a gap between start and length indicator values (SLIVs) or within an SLIV; obtain or send, in the second time span, a third reference signal; and obtain or send a shared channel based on these signals. The methods and apparatuses provide enhanced phase continuity and accurate channel estimation, improving system performance and efficiency.

### TECHNICAL FIELD

The present disclosure relates to wireless communication, and more particularly, to methods and apparatuses for maintaining phase continuity and optimizing channel estimation in systems utilizing multiple coherent demodulation reference signal (DMRS) ports through the use of a glue reference signal (gRS).

### DESCRIPTION OF THE RELATED TECHNOLOGY

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (cMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

One innovative aspect of the subject matter described in this disclosure may be implemented in an apparatus for wireless communication, where the apparatus is a user equipment (UE). The apparatus includes one or more memories, and one or more processors each communicatively coupled with at least one of the one or more memories. The one or more processors, individually or in any combination, are operable to cause the apparatus to obtain, in a first time span, a first reference signal associated with multiple coherent ports in a code division multiplexing (CDM) group; obtain, in a second time span prior to the first time span, a second reference signal associated with at least one tone and code division multiplexed based on the multiple coherent ports for the first reference signal, the second reference signal being configured for compensation of a phase change across a gap between the second time span and the first time span; obtain, in the second time span, a third reference signal associated with the multiple coherent ports in the CDM group; and obtain a physical downlink shared channel (PDSCH), or send a physical uplink shared channel (PUSCH), in the second time span or the first time span based at least in part on the second reference signal and a combination of the first reference signal and the third reference signal, the first time span and the second time span respectively corresponding to different start and length indicator values (SLIVs) or different slots of a same SLIV.

Another innovative aspect of the subject matter described in this disclosure may be implemented in a method of wireless communication performable at a UE. The method includes obtaining, in a first time span, a first reference signal associated with multiple coherent ports in a CDM group; obtaining, in a second time span prior to the first time span, a second reference signal associated with at least one tone and code division multiplexed based on the multiple coherent ports for the first reference signal, the second reference signal being configured for compensation of a phase change across a gap between the second time span and the first time span; obtaining, in the second time span, a third reference signal associated with the multiple coherent ports in the CDM group; and obtaining a PDSCH, or sending a PUSCH, in the second time span or the first time span based at least in part on the second reference signal and a combination of the first reference signal and the third reference signal, the first time span and the second time span respectively corresponding to different SLIVs or different slots of a same SLIV.

Another innovative aspect of the subject matter described in this disclosure may be implemented in an apparatus for wireless communication, where the apparatus is a network entity. The apparatus includes one or more memories, and one or more processors each communicatively coupled with at least one of the one or more memories. The one or more processors, individually or in any combination, are operable to cause the apparatus to send, in a first time span, a first reference signal associated with multiple coherent ports in a CDM group; send, in a second time span prior to the first time span, a second reference signal associated with at least one tone and code division multiplexed based on the multiple coherent ports for the first reference signal, the second reference signal being configured for compensation of a phase change across a gap between the second time span and the first time span; send, in the second time span, a third reference signal associated with the multiple coherent ports in the CDM group; and send a PDSCH, or obtain a PUSCH, in the second time span or the first time span based at least in part on the second reference signal and a combination of the first reference signal and the third reference signal, the first time span and the second time span respectively corresponding to different SLIVs or different slots of a same SLIV.

Another innovative aspect of the subject matter described in this disclosure may be implemented in a method of wireless communication performable at a network entity. The method includes sending, in a first time span, a first reference signal associated with multiple coherent ports in a CDM group; sending, in a second time span prior to the first time span, a second reference signal associated with at least one tone and code division multiplexed based on the multiple coherent ports for the first reference signal, the second reference signal being configured for compensation of a phase change across a gap between the second time span and the first time span; sending, in the second time span, a third reference signal associated with the multiple coherent ports in the CDM group; and sending a PDSCH, or obtaining a PUSCH, in the second time span or the first time span based at least in part on the second reference signal and a combination of the first reference signal and the third reference signal, the first time span and the second time span respectively corresponding to different SLIVs or different slots of a same SLIV.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1A is a diagram illustrating an example of a wireless communications system and an access network.

FIG. 1B shows a diagram illustrating an example disaggregated base station architecture.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating an example of an overlapping sliding channel estimation window.

FIGS. 5A-5B are diagrams illustrating examples of a single-port demodulation reference signal (DMRS) in different slots which are jointly estimated during causal and noncausal combining, respectively.

FIG. 6 is a diagram illustrating an example of a gap between slots where phase continuity may not be maintained between single-port DMRS shared slots.

FIG. 7 is a diagram illustrating an example of a glue reference signal (gRS) that a transmitter may send to maintain phase continuity across a physical or logical gap between different time segments, such as different slots.

FIG. 8 is a diagram illustrating an example of a gRS designed to apply in multi-port repetition for code division multiplexed (CDMed) DMRS ports.

FIG. 9 is a diagram illustrating another example of a single tone gRS implemented for multi-port repetition in coherent CDMed DMRS ports.

FIG. 10 is a diagram illustrating an example of port repetition and scrambling of gRS in CDMed DMRS ports.

FIG. 11 is a diagram illustrating an example of gRS repetition in alternating, even tones and odd tones to achieve frequency diversity and multiport gRS gain harvesting.

FIG. 12 is a call flow diagram between a UE and a base station.

FIG. 13 is a flowchart of a method of wireless communication performable at a UE.

FIG. 14 is a flowchart of a method of wireless communication performable at a network entity.

FIG. 15 is a diagram illustrating an example of a hardware implementation for an example apparatus.

FIG. 16 is a diagram illustrating another example of a hardware implementation for another example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

In wireless communication systems, enhancing the coverage and efficiency of the physical uplink shared channel (PUSCH) is important. To allow the allocation of PUSCH or physical downlink shared channel (PDSCH) resources to span across slot boundaries, a flexible start and length indicator value (SLIV) design has been introduced. This design aims to reduce the overhead of demodulation reference signals (DMRSs) by applying a more uniform time-domain DMRS pattern within channel estimation windows. Within each window, a transmitter, such as a user equipment (UE) or base station, may interpolate the channel, allowing for more efficient use of DMRS symbols.

However, while fluidly designing SLIVs to uniformly distribute DMRS over channel estimation windows may minimize overhead, DMRS sharing across same or different SLIVs may result in further optimizations. For instance, a UE may apply causal or non-causal combining of DMRS in different SLIVs, or in different slots of a same SLIV, to enhance the efficiency of channel estimation and reduce overhead. By sharing DMRS across SLIVs or slots and combining them, the UE may decode PDSCH symbols more effectively, whether in present or past SLIVs or slots. Yet, to fully exploit the benefits of DMRS combining or joint DMRS processing in fluid SLIVs, it is important to address phase jumps or gain changes that may occur within or between SLIVs. For instance, a physical or logical gap between two slots including shared single-port DMRS may disrupt phase continuity between the slots. Since this disruption can degrade performance, the UE compensates for phase jumps or gain changes before performing any causal or non-causal combining for PDSCH or PUSCH decoding. However, in high Doppler scenarios, traditional methods of phase estimation may become less effective, as the phase jump and Doppler shift can be difficult to distinguish, complicating accurate joint channel estimation.

To address these challenges, a glue reference signal (gRS) is introduced to maintain phase continuity across gaps where phase jumps or gain state changes can occur. The gRS may help the receiver identify and address phase inconsistencies from slot to slot, SLIV to SLIV, or across other boundaries. In various aspects of the present disclosure, the gRS may be designed for multi-port repetition for code division multiplexed (CDMed) DMRS ports, allowing the phase jump to be estimated directly from the descrambled received signal without the need for per-port channel estimation. More particularly, a single-tone gRS may be implemented for multi-port repetition to reduce overhead while maintaining effective phase jump estimation. The gRS may be applied with orthogonal cover codes and repeated over active DMRS ports to provide for accurate phase continuity and channel estimation, even in high Doppler scenarios. By configuring and placing gRSs around potential gaps and using them in conjunction with DMRS, the network may maintain phase continuity and allow the UE to achieve accurate channel estimation during noncausal or causal combining, thereby improving overall performance.

Accordingly, various aspects of the subject matter described in this disclosure relate generally to wireless communication, and more particularly to maintaining phase continuity and optimizing channel estimation in systems utilizing multiple coherent DMRS ports through the use of a gRS. Some aspects specifically relate to the design and implementation of gRS for multi-port repetition in CDMed DMRS ports to address phase jumps and gain changes. In various examples, apparatuses and methods are provided in which a UE obtains, in a first time span, a first reference signal associated with multiple coherent ports in a CDM group; obtains, in a second time span prior to the first time span, a second reference signal associated with at least one tone and code division multiplexed based on the multiple coherent ports for the first reference signal, the second reference signal being configured for compensation of a phase change across a gap between the second time span and the first time span; obtains, in the second time span, a third reference signal associated with the multiple coherent ports in the CDM group; and obtains a PDSCH, or sends a PUSCH, in the second time span or the first time span based at least in part on the second reference signal and a combination of the first reference signal and the third reference signal, the first time span and the second time span respectively corresponding to different SLIVs or different slots of a same SLIV. Similar apparatuses and methods are provided in which a network entity such as a base station sends the first reference signal, the second reference signal, and the third reference signal, as previously described, and which obtains a PUSCH or sends a PDSCH in the second time span or the first time span based at least in part on the second reference signal and a combination of the first reference signal and the third reference signal. Additional aspects for both the UE and network entity relate to the specific configurations and applications of the gRS, such as its reception in single subcarriers within multiple resource blocks (RBs), its repetition over multiple coherent ports, and its application with orthogonal cover codes to ensure accurate phase continuity and channel estimation.

Thus, particular aspects of the subject matter described in this disclosure may be implemented to realize one or more potential advantages. For example, the disclosed methods and apparatuses may provide enhanced phase continuity and accurate channel estimation, even in high Doppler scenarios, thereby improving overall system performance. This may be achieved by a receiver of PDSCH or PUSCH, such as a UE or base station respectively, obtaining and combining multiple reference signals across different SLIVs or different slots within a same SLIV, using a gRS to compensate for phase jumps and gain changes, and applying causal or non-causal combining techniques to decode PDSCH or PUSCH effectively. In addition, the disclosed methods and apparatuses may provide reduced overhead and increased efficiency in resource utilization. These advantages can be realized through the specific configurations of the gRS, such as its reception in single subcarriers within multiple RBs, its repetition over multiple coherent ports, and its application with OCCs, which allow for the gRS to capture the same channel responses as the DMRS, facilitating accurate phase jump estimation and maintaining phase continuity.

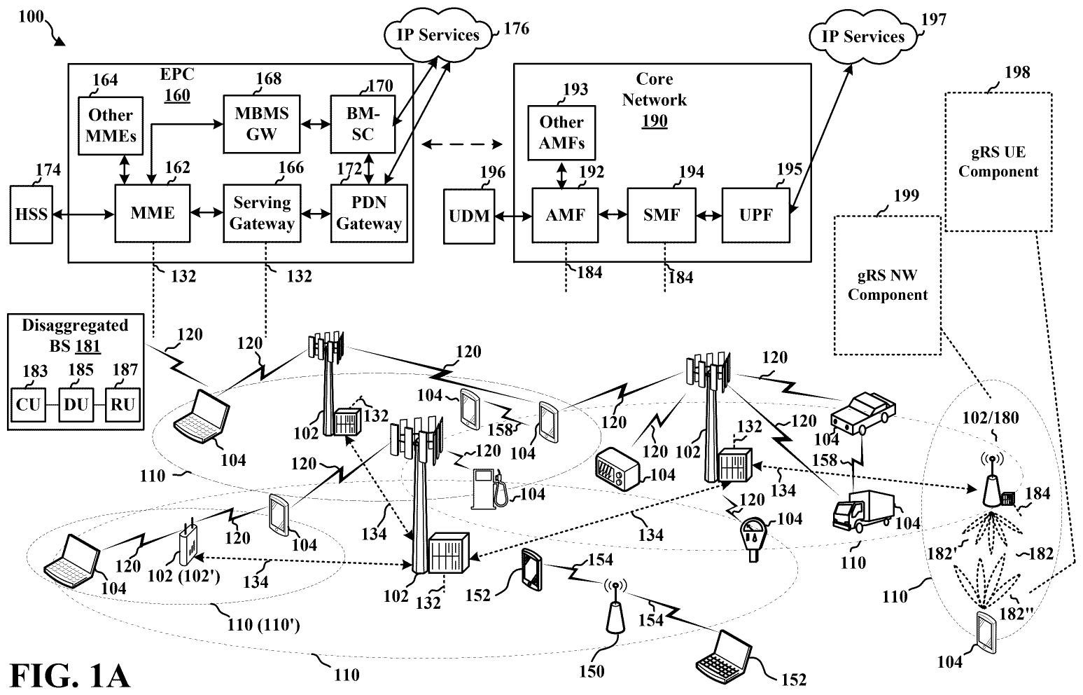

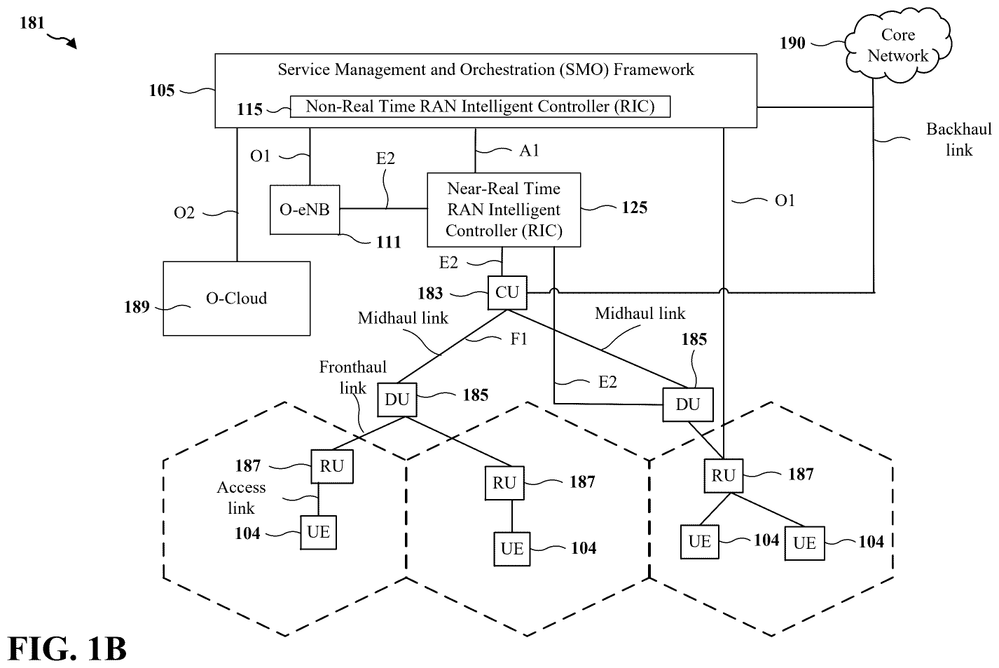

FIG. 1A is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). The frequencies between FR1 and FR2 are often referred to as mid-band frequencies. Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHZ spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Deployment of communication systems, such as 5G NR systems, may be arranged in multiple manners with various components or constituent parts. In a 5G NR system, or network, a network node, a network entity, a network device, a mobility element of a network, a RAN node, a core network node, a network element, or a network equipment, such as a BS, or one or more units (or one or more components) performing base station functionality, may be implemented in an aggregated or disaggregated architecture. For example, a BS (such as a Node B (NB), eNB, NR BS, 5G NB, access point (AP), a TRP, or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station 181 may be configured to utilize a protocol stack that is physically or logically distributed among two or more units (such as one or more central units (CU), one or more distributed units (DUs), or one or more radio units (RUs)). In some aspects, a CU 183 may be implemented within a RAN node, and one or more DUs 185 may be co-located with the CU, or alternatively, may be geographically or virtually distributed throughout one or multiple other RAN nodes. The DUs may be implemented to communicate with one or more RUs 187. Each of the CU, DU and RU also may be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which may enable flexibility in network design. The various units of the disaggregated base station, or disaggregated RAN architecture, may be configured for wired or wireless communication with at least one other unit.

FIG. 1B shows a diagram illustrating an example disaggregated base station 181 architecture. The disaggregated base station 181 architecture may include one or more CUs 183 that may communicate directly with core network 190 via a backhaul link, or indirectly with the core network 190 through one or more disaggregated base station units (such as a Near-Real Time RIC 125 via an E2 link, or a Non-Real Time RIC 115 associated with a Service Management and Orchestration (SMO) Framework 105, or both). A CU 183 may communicate with one or more DUs 185 via respective midhaul links, such as an F1 interface. The DUs 185 may communicate with one or more RUs 187 via respective fronthaul links. The RUs 187 may communicate respectively with UEs 104 via one or more radio frequency (RF) access links. In some implementations, the UE 104 may be simultaneously served by multiple RUs 187.

Each of the units, i.e., the CUs 183, the DUs 185, the RUs 187, as well as the Near-RT RICs 125, the Non-RT RICs 115 and the SMO Framework 105, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units. Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the CU 183 may host higher layer control functions. Such control functions may include radio resource control (RRC), packet data convergence protocol (PDCP), service data adaptation protocol (SDAP), or the like. Each control function may be implemented with an interface configured to communicate signals with other control functions hosted by the CU 183. The CU 183 may be configured to handle user plane functionality (i.e., Central Unit-User Plane (CU-UP)), control plane functionality (i.e., Central Unit-Control Plane (CU-CP)), or a combination thereof. In some implementations, the CU 183 may be logically split into one or more CU-UP units and one or more CU-CP units. The CU-UP unit may communicate bidirectionally with the CU-CP unit via an interface, such as the E1 interface when implemented in an O-RAN configuration. The CU 183 may be implemented to communicate with the DU 185, as necessary, for network control and signaling.

The DU 185 may correspond to a logical unit that includes one or more base station functions to control the operation of one or more RUs 187. In some aspects, the DU 185 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 185 may further host one or more low PHY layers. Each layer (or module) may be implemented with an interface configured to communicate signals with other layers (and modules) hosted by the DU 185, or with the control functions hosted by the CU 183.

Lower-layer functionality may be implemented by one or more RUs 187. In some deployments, an RU 187, controlled by a DU 185, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 187 may be implemented to handle over the air (OTA) communication with one or more UEs 104. In some implementations, real-time and non-real-time aspects of control and user plane communication with the RU(s) 187 may be controlled by the corresponding DU 185. In some scenarios, this configuration may enable the DU(s) 185 and the CU 183 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements, which may be managed via an operations and maintenance interface (such as an O1 interface). For virtualized network elements, the SMO Framework 105 may be configured to interact with a cloud computing platform (such as an open cloud (O-Cloud) 189) to perform network element life cycle management (such as to instantiate virtualized network elements) via a cloud computing platform interface (such as an O2 interface). Such virtualized network elements may include, but are not limited to, CUs 183, DUs 185, RUs 187 and Near-RT RICs 125. In some implementations, the SMO Framework 105 may communicate with a hardware aspect of a 4G RAN, such as an open eNB (O-CNB) 111, via an O1 interface. Additionally, in some implementations, the SMO Framework 105 may communicate directly with one or more RUs 187 via an O1 interface. The SMO Framework 105 also may include the Non-RT RIC 115 configured to support functionality of the SMO Framework 105.

The Non-RT RIC 115 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 183, one or more DUs 185, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

Referring to FIGS. 1A and 1B, in certain aspects, the UE 104 may include a glue reference signal (gRS) UE component 198 that is configured to obtain, in a first time span, a first reference signal associated with multiple coherent ports in a CDM group; obtain, in a second time span prior to the first time span, a second reference signal associated with at least one tone and code division multiplexed based on the multiple coherent ports for the first reference signal, the second reference signal being configured for compensation of a phase change across a gap between the second time span and the first time span; obtain, in the second time span, a third reference signal associated with the multiple coherent ports in the CDM group; and obtain a PDSCH, or send a PUSCH, in the second time span or the first time span based at least in part on the second reference signal and a combination of the first reference signal and the third reference signal, the first time span and the second time span respectively corresponding to different SLIVs or different slots of a same SLIV. The UE may receive reference signals and data from, and send data to, base station 102/180, disaggregated base station 181, a component of disaggregated base station 181 such as CU 183, DU 185, or RU 187, or some other network entity.

Furthermore, in certain aspects, a network entity such as base station 102/180, disaggregated base station 181, or a component of disaggregated base station 181 such as CU 183, DU 185, or RU 187, may include gRS network (NW) component 199 that is configured to send, in a first time span, a first reference signal associated with multiple coherent ports in a CDM group; send, in a second time span prior to the first time span, a second reference signal associated with at least one tone and code division multiplexed based on the multiple coherent ports for the first reference signal, the second reference signal being configured for compensation of a phase change across a gap between the second time span and the first time span; send, in the second time span, a third reference signal associated with the multiple coherent ports in the CDM group; and send a PDSCH, or obtain a PUSCH, in the second time span or the first time span based at least in part on the second reference signal and a combination of the first reference signal and the third reference signal, the first time span and the second time span respectively corresponding to different SLIVs or different slots of a same SLIV. The network entity may send reference signals and data to, and receive data from, UE 104 or a different UE.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

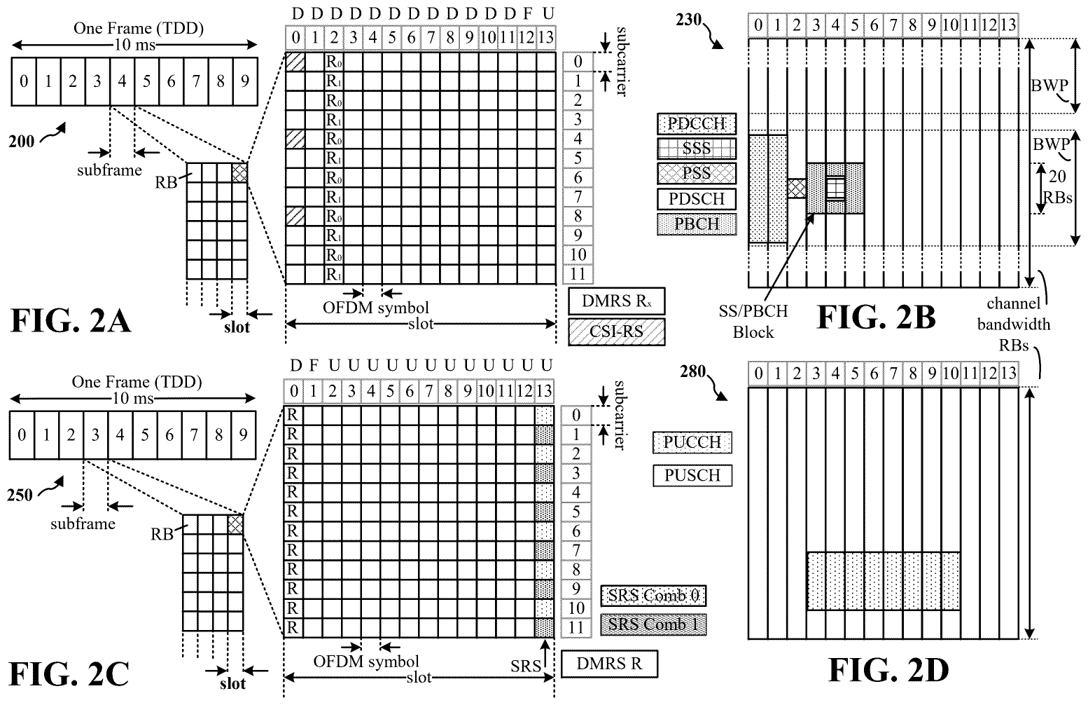

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2^{μ} slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data and may additionally be used to carry a buffer status report (BSR), a power headroom report (PHR), and/or UCI.

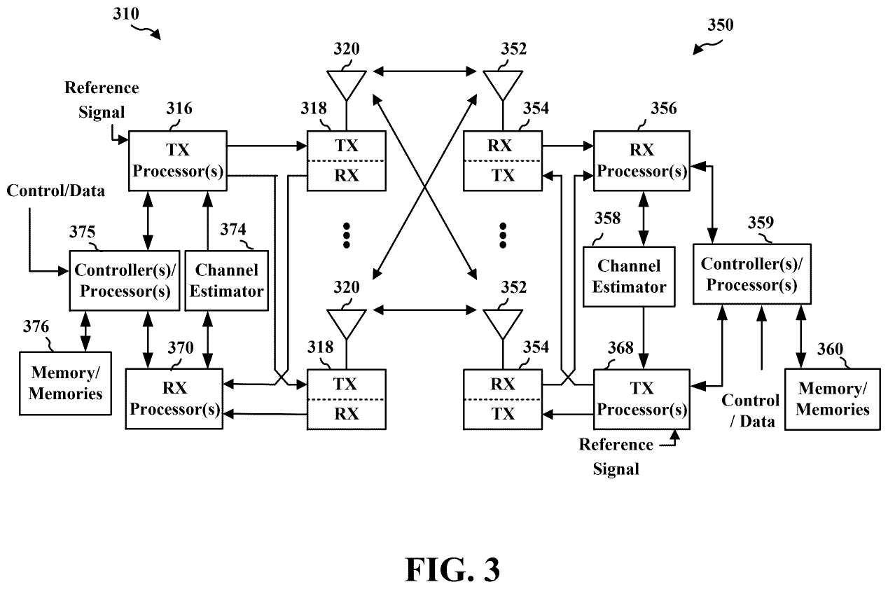

FIG. 3 is a block diagram of a base station 310 in communication with a UE 350 in an access network. In the DL, IP packets from the EPC 160 may be provided to one or more controllers/processors 375. The one or more controllers/processors 375 implement layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The one or more controllers/processors 375 provide RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The one or more transmit (TX) processors 316 and the one or more receive (RX) processors 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The one or more TX processors 316 handle mapping to signal constellations based on various modulation and coding schemes (MCS) (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the one or more receive (RX) processors 356. The one or more TX processors 368 and the one or more RX processors 356 implement layer 1 functionality associated with various signal processing functions. The one or more RX processors 356 may perform spatial processing on the information to recover any spatial streams destined for the UE 350. If multiple spatial streams are destined for the UE 350, they may be combined by the one or more RX processors 356 into a single OFDM symbol stream. The one or more RX processors 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the one or more controllers/processors 359, which implement layer 3 and layer 2 functionality.

The one or more controllers/processors 359 may each be associated with one or more memories 360 that store program codes and data. The one or more memories 360, individually or in any combination, may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). In the UL, the one or more controllers/processors 359 provide demultiplexing between transport and logical channels, packet reassembly, deciphering, header decompression, and control signal processing to recover IP packets from the EPC 160. The one or more controllers/processors 359 are also responsible for error detection using an ACK and/or NACK protocol to support HARQ operations.

Similar to the functionality described in connection with the DL transmission by the base station 310, the one or more controllers/processors 359 provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the one or more TX processors 368 to select the appropriate coding and modulation schemes, and to facilitate spatial processing. The spatial streams generated by the one or more TX processors 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to one or more RX processors 370.

The one or more controllers/processors 375 may each be associated with one or more memories 376 that store program codes and data. The one or more memories 376, individually or in any combination, may be referred to as a computer-readable medium and may be any of the types of computer-readable mediums discussed herein (e.g., RAM, ROM, EEPROM, optical disk storage, magnetic disk storage, other magnetic storage devices, combinations of the aforementioned types of computer-readable media, or any other medium that can be used to store computer executable code in the form of instructions or data structures that can be accessed by a computer). In the UL, the one or more controllers/processors 375 provide demultiplexing between transport and logical channels, packet reassembly, deciphering, header decompression, control signal processing to recover IP packets from the UE 350. IP packets from the one or more controllers/processors 375 may be provided to the EPC 160. The one or more controllers/processors 375 are also responsible for error detection using an ACK and/or NACK protocol to support HARQ operations.

At least one of the one or more TX processors 368, the one or more RX processors 356, and the one or more controllers/processors 359 may be configured to perform aspects in connection with gRS UE component 198 of FIG. 1A.

At least one of the one or more TX processors 316, the one or more RX processors 370, and the one or more controller/processors 375 may be configured to perform aspects in connection with gRS NW component 199 of FIG. 1A.

Repeated physical uplink shared channel (PUSCH) transmissions may be used to enhance PUSCH coverage. This enhancement may be achieved through the use of multiple segments of back-to-back symbols for each repeated PUSCH transmission. Each repetition of the PUSCH transmission generally employs a different redundancy version (RV), such that each segment remains within the boundaries of a slot. This allows for a transmitter such as UE 104 to avoid any crossing of slot boundaries when sending the PUSCH, maintaining the integrity and efficiency of the transmission process.

However, a more flexible start and length indicator value (SLIV) design has been introduced that allows the allocation of PUSCH resources or physical downlink shared channel (PDSCH) resources to span across slot boundaries. One of the key considerations in this design is the reduction of demodulation reference signal (DMRS) overhead. By applying a more uniform time-domain DMRS pattern, which incorporates the benefits of both DMRS and cell-specific reference signals (CRS), the system may better handle Doppler effects and reduce the time-domain density of DMRS, which is important for efficient channel estimation and resource utilization.

To achieve this reduction in DMRS density, a group of DMRS symbols may be exploited within a specific time span, referred to as a channel estimation window. Within this window, a transmitter such as UE 104 or base station 102/180 may interpolate the channel, allowing for a more efficient use of DMRS symbols. The size of this channel estimation window may be dependent on transmitter buffer constraints, which dictate how much data can be processed and stored by the transmitter at any given time.

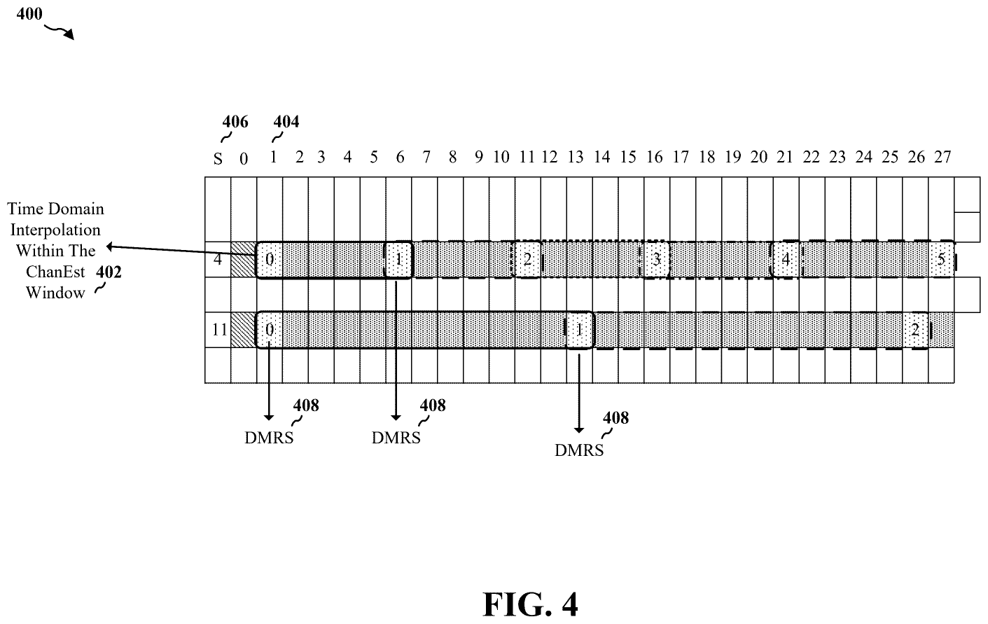

FIG. 4 illustrates an example 400 of an overlapping sliding channel estimation window 402. This window 402 may span multiple time-domain symbols 404, allowing for interpolation within the channel estimation window. The overlapping nature of the window 402 allows the transmitter to perform continuous and accurate channel estimation, even as the transmitter moves through different time-domain symbols. This method of time-domain interpolation within the channel estimation window is depicted in FIG. 4 through a series of symbols each corresponding to an SLIV 406, where DMRS 408 symbols are strategically placed to facilitate efficient channel estimation. For instance, in the example of FIG. 4, short, 4-symbol SLIVs and long, 11-symbol SLIVs are depicted at different starting symbols each preceded by a DMRS. In this example, the DMRSs 408 are transmitted using a single port, and thus may be referred to as single-port DMRS. Here, SLIVs 406 may be flexibly or fluidly within a slot or spanning across slots, such as the 14-symbol slots illustrated in FIG. 4.

With multiple SLIVs 406 such as illustrated in FIG. 4, the base station may make scheduling decisions on the fly, without requiring pre-committed scheduling. This flexibility is particularly helpful for bursty traffic, where there may be a high chance for the base station to schedule data to or from a UE back-to-back with the same precoder. Given the low duty cycle of sounding reference signal (SRS) transmission or channel state information (CSI) reports, there is no strong reason for the base station to change precoders frequently at the beginning.

However, while fluidly designing SLIVs 406 to uniformly distribute DMRS 408 over a time duration may minimize overhead, such as uniformly over the 28 symbols illustrated in FIG. 4, DMRS sharing across different SLIVs or across different slots within a same SLIV may result in further optimizations. For instance, a UE may apply causal or non-causal combining of DMRS to enhance the efficiency of channel estimation and reduce overhead. Causal combining is when the UE uses DMRS or channel estimates from previous TTIs to estimate the current channel. For example, the UE may buffer the DMRS or channel estimates in a previous slot or SLIV including data intended for either the same or a different UE, and then the UE may use the DMRS or channel estimates to jointly estimate the channels in a current slot or SLIV. In contrast, non-causal combining is when the UE waits for the next front-loaded DMRS in a subsequent TTI to perform joint channel estimation. For instance, the base station may instruct the receiving UE to wait for the next DMRS in a future slot or SLIV including data intended for either the same or a different UE, and after receiving this DMRS, the UE may perform joint channel estimation using time interpolation for the past slot or SLIV. Either type of DMRS combining may be helpful to achieve higher data rates. For example, by exploiting the DMRS from prior symbols in causal combining, channel estimation quality and, consequently, throughput, may significantly be improved. Moreover, the accuracy of PDSCH symbol decoding may similarly be improved, either in present slots or present SLIVs from causal combining or in past slots or past SLIVs from non-causal combining. For instance, by sharing DMRS across slots or SLIVs and combining them, the UE may decode PDSCH symbols more effectively, whether in present or past slots or SLIVs.

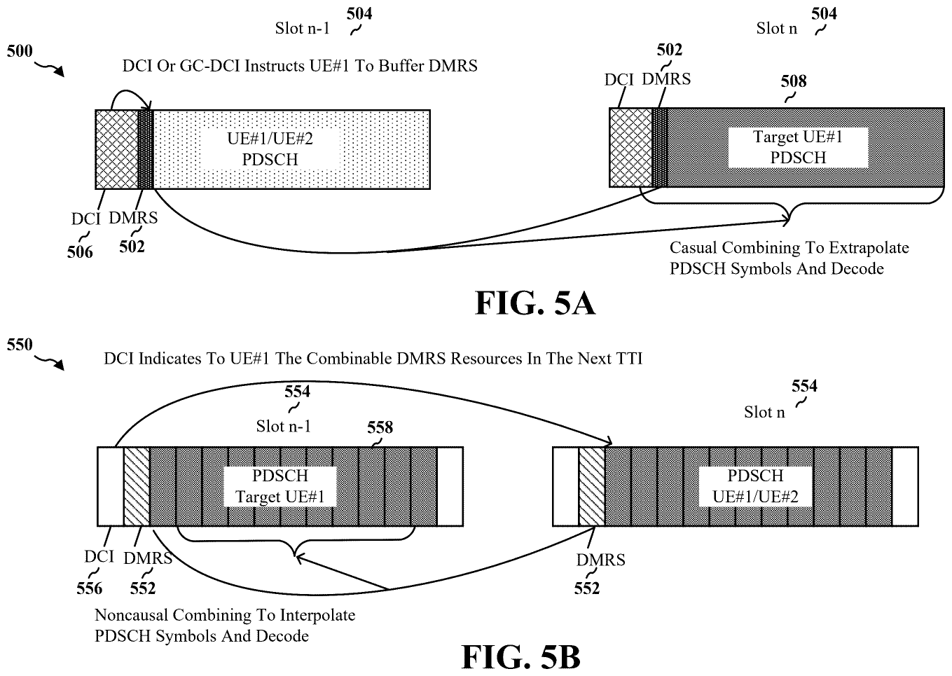

FIGS. 5A and 5B illustrate examples 500, 550 of the exploitation of single-port DMRS in different slots jointly to achieve optimization of DMRS overhead and performance. The slots may be in different short SLIVs, such as the 4-symbol SLIVs in FIG. 4, or within a same long SLIV, such as the 11-symbol SLIV in FIG. 4. For example, for downlink (DL) transmissions, combinable DMRS resources 502, 552 in adjacent transmission time intervals 504, 554 (TTIs) may be indicated to the receiving UE. The UE may then be instructed to perform cross-SLIV or cross-slot combining to significantly reduce DMRS overhead. For instance, in the example of FIG. 5A, in slot n−1, a downlink control information 506, 556 (DCI) or group common DCI (GC-DCI) may instruct UE1 to buffer the DMRS 408 in DMRS resources 502, 552. Then, in slot n, the base station may transmit PDSCH 508 to the target UE1, and the UE may apply causal combining of the DMRS 408 symbols to extrapolate the PDSCH 508 symbols and decode them. Alternatively, in the example of FIG. 5B, in slot n−1, the downlink control information 556 may indicate to UE1 the combinable DMRS resources 552 in the next TTI such as slot n. Then in slot n, the UE may apply non-causal combining to interpolate PDSCH 558 symbols from slot n−1 and decode them. While the aforementioned examples refer tor intra-UE sharing, these examples may also be extended to inter-UE sharing. For instance, the causal combining of FIG. 5A and the non-causal combining of FIG. 5B may be applied based on DMRS in prior or future slots or SLIVs including data intended for a different UE. Furthermore, while the aforementioned examples refer to PDSCH decoding and DMRS transmission from a base station, these examples may also be extended to PUSCH decoding and DMRS transmission from a UE. Additionally, while the aforementioned examples all refer to DMRS for channel estimation purposes, in other examples, different reference signals than DMRS may be used for similar purposes.

However, to exploit the benefits of DMRS 408 combining or joint DMRS processing in fluid SLIVs, whether for DMRS overhead saving or for enhanced performance such as illustrated in FIG. 5A or 5B, it is important for the receiver to compensate for any phase jumps or gain changes that may occur between the SLIVs 406, slots or transmission time intervals 504, 554. For instance, a potential phase discontinuity and gain state change may occur across a physical or logical gap between one SLIV, slot, or TTI such as slot n−1 and another SLIV, slot or TTI such as slot n sharing DMRS resources 502, 552 in the examples 500, 550 of FIG. 5A or 5B. Such physical or logical gaps may arise due to various reasons, including, for example, a radio frequency (RF) reconfiguration, transmission (Tx)/Rx switching, an SRS transmission, or the like occurring between the SLIVs, slots or TTIs. When such gaps occur, they may disrupt the phase continuity between the DMRS shared SLIVs, slots or TTIs, leading to inaccurate channel estimation or decoding of the PDSCH or PUSCH resources and thus performance degradation. Thus, it would be helpful for such gaps to be addressed before any causal or non-causal combining for PDSCH or PUSCH decoding.

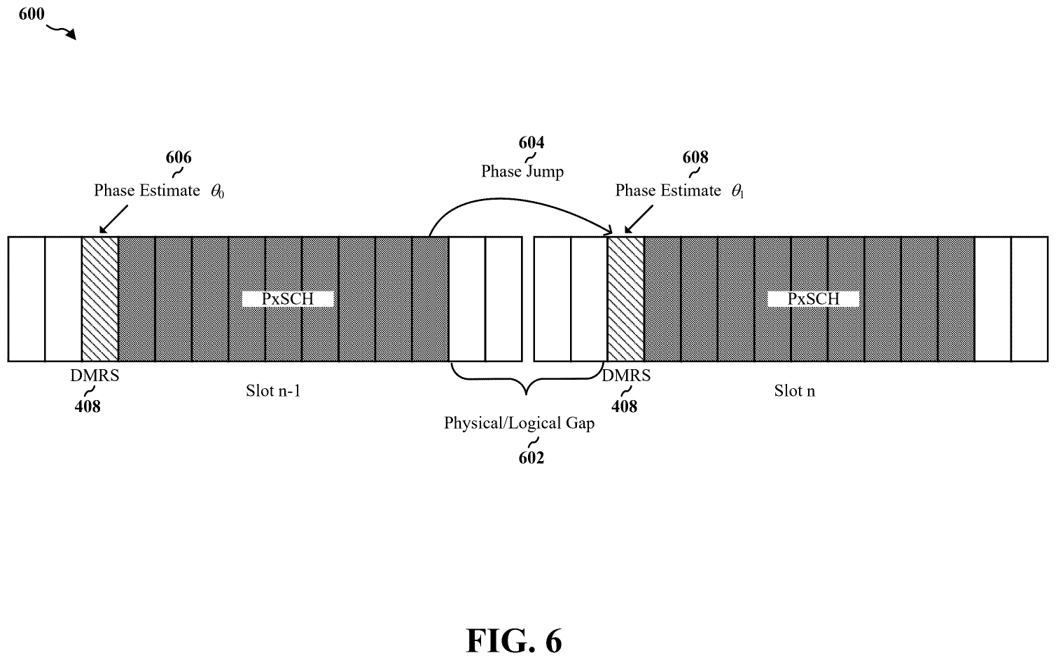

FIG. 6 illustrates an example 600 of a gap 602 between TTIs, such as a physical or logical gap between slot n−1 and slot n, where phase continuity may not be maintained between single-port DMRS shared slots. A receiver, such as a UE for PDSCH or a base station for PUSCH, may determine the presence of gap 602 either through prior configuration or through an indication that a transmitter previously provides to it, such as a base station for PDSCH or a UE for PUSCH. The transmitter may inform the receiver of the potentiality or actuality of this gap 602 a priori, that is, before any causal combining or non-causal combining is eventually performed. Based on this information, the receiver may prepare for the potential or actual discontinuity between slot n−1 and slot n, or between other TTIs, and take compensatory actions.

For instance, in scenarios with low Doppler effects, the receiver may determine a phase jump 604 from the DMRS 408 symbols obtained during the two time segments sharing DMRS 408. For example, the receiver may determine a phase estimate 606 from the DMRS in slot n−1 and a phase estimate 608 from the DMRS in slot n, and the receiver may compare these phase estimates 606, 608 to determine the phase jump 604. For instance, the phase jump 604 may be calculated as the difference between these two phase estimates 606, 608. After identifying the phase jump 604, the receiver may apply corrections to allow for more accurate signal processing. For example, based on the phase jump 604, the receiver may determine Rx gain state changes before DMRS combining, or the transmitter may estimate Tx gain state changes from the DMRS symbols in the two different time segments being DMRS shared. Afterwards, the receiver may adjust its processing between slot n−1 and slot n, for example, by compensating for the determined or estimated Rx or Tx gain state changes. Thus, phase continuity may be maintained even in the presence of gap 602. As a result of this maintained phase continuity, the receiver may proceed to apply causal or noncausal combining of the DMRS 408 to extrapolate or interpolate and decode the PDSCH or PUSCH, such as previously described in connection with FIG. 5A or 5B.

Yet, when dealing with higher Doppler cases, traditional methods of phase estimation may become less effective since the phase jump and Doppler shift can be difficult to distinguish. For example, if any of the DMRS 408 are too far from the gap 602 in high Doppler scenarios, such as at the beginning of slot n−1 in the example of FIG. 6, the phase estimates 606, 608 obtained from the two DMRS resources may include both the phase jump 604 and the Doppler shift. This may make accurate joint channel estimation during causal or non-causal combining challenging, since in high Doppler scenarios, the Doppler shift and phase jump 604 may become indistinguishable from the two estimations of DMRS 408 symbols across the gap 602.

To address these challenges, a reference signal dedicated for this purpose, referred to throughout this disclosure as a glue reference signal (gRS), may be provided around potential or actual logical or physical gaps where phase jumps 604 or gain state changes can occur. This gRS may help the receiver identify and address phase inconsistencies from slot to slot, SLIV to SLIV, or across other boundaries. For example, gRSs may be inserted around the gap 602 between slot boundaries illustrated in FIG. 6, between short SLIV boundaries, or inside a slot or a long SLIV such as the slots or SLIVs illustrated in FIG. 4, 5A, or 5B. The placement of gRSs adjacent to the gap 602, or other reference signals serving a similar purpose around the gap 602, may allow the receiver to derive the phase difference between slots and SLIVs from tone to tone and compensate for the phase jump 604 accurately even in high Doppler scenarios. Thus, phase continuity may be maintained and accurate channel estimation may continue to be obtained.

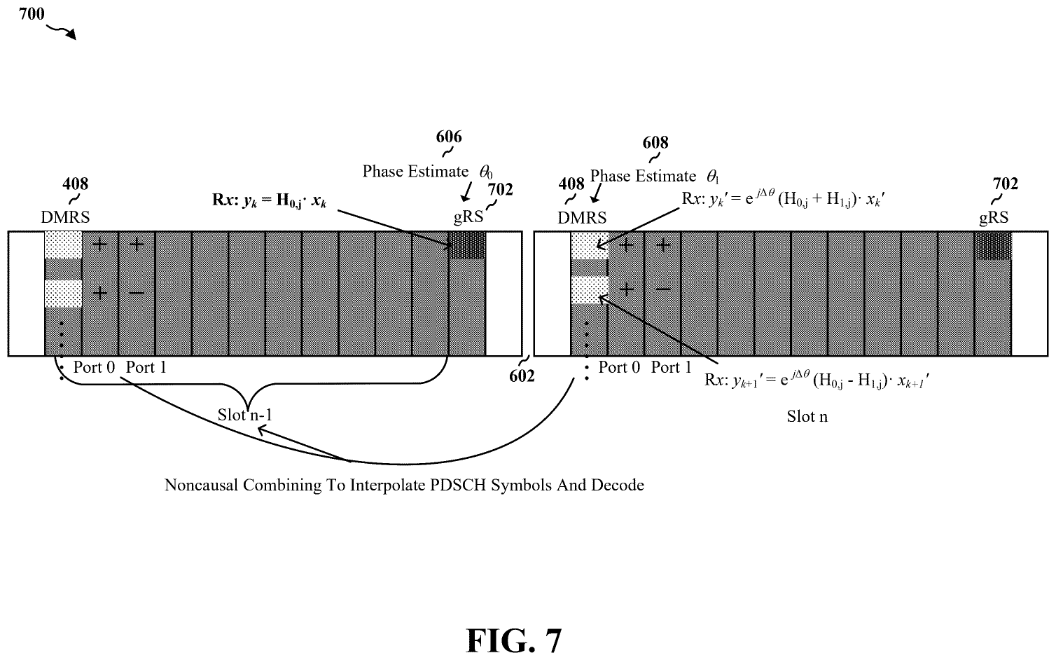

FIG. 7 illustrates an example 700 of a gRS 702 that the transmitter may send to maintain phase continuity across a physical or logical gap between different time segments, such as different slots or SLIVs 406. For instance, gRS 702 may be transmitted to bridge the gap 602 between slot n−1 and slot n in the prior examples. More particularly, in scenarios where phase jump 604 may occur due to for example, a RF reconfiguration, Tx/Rx switching, an SRS transmission, or the like, one or more gRSs 702 may be inserted before or after the phase jump boundary or gap 602. These gRSs may be sparse in the frequency domain and may be located in the same frequency tone or tones across the boundary or gap 602, such as illustrated in both slots of FIG. 7. In some cases, DMRS 408 adjacent to and transmitted on one side of the phase jump boundary may be reused as gRS 702 to maintain continuity. For instance, the gRS 702 near the end of slot n−1 in the example of FIG. 7 may be a DMRS reused for phase continuity maintaining purposes, as well as for channel estimation purposes.

In various examples, a phase tracking reference signal (PTRS) may be used as gRS 702 to maintain phase continuity across gap 602, without introducing significant additional overhead or complexity. For example, a PTRS waveform and frequency domain pattern may be used for gRS 702, such that the PTRS-as-gRS occupies one RE in every two or four or other quantity of RBs, and such that the PTRS-as-gRS punctures the PDSCH or PUSCH. This frequency domain mapping may provide a low overhead without affecting PDSCH or PUSCH rate matching. As for the time domain pattern, instead of configuring gRS 702 every one, two, or four symbols such as typically used for PTRS, the gRS may be configured simply in one or more PTRS symbols adjacent to gap 602, such as illustrated in FIG. 7. This targeted placement allows the gRS resources to be optimally utilized around the potential logical or physical gap where phase jump 604 may occur, rather than everywhere PTRS may typically be placed. Moreover, if the PTRS symbol reused as gRS 702 happens to overlap with DMRS 408, the gRS 702 may be dropped in favor of the DMRS 408 to avoid redundancy and maintain efficiency. In such case, this DMRS may be used for the joint channel estimation purpose, rather than the dropped gRS, to mitigate the effects of phase discontinuity and gain state changes. For instance, the DMRS 408 near the beginning of slot n in the example of FIG. 7 may be used in place of an overlapping gRS that was dropped in favor of the DMRS for phase continuity maintaining purposes, as well as channel estimation purposes.

Regardless of whether the gRS 702 is implemented from PTRS or some other reference signal, the receiver may use the gRS(s) or other reference signals placed around the gap 602 to determine the phase jump 604 for joint channel estimation. For instance, the receiver may obtain the phase estimates 606, 608 respectively from the gRS 702 symbol at slot n−1 and the DMRS 408 symbol at slot n, and from these estimates, the receiver may determine the corresponding phase jump 604 across gap 602. Using this information regarding the phase jump 604, the receiver may apply noncausal combining to decode the PDSCH or PUSCH as previously described. Alternatively, the receiver may apply causal combining to decode the PDSCH or PUSCH as previously described. Thus, phase continuity may continue to be maintained and PDSCH and PUSCH decoding may be facilitated even in high Doppler scenarios.

However, while joint channel estimation in high Doppler scenarios may be performed accurately using single-port gRS when the DMRS is similarly transmitted from a single port, further complications may arise when the DMRS 408 is transmitted from multiple ports. These antenna ports may be non-coherent or coherent. Non-coherent ports are those where the phase and amplitude of the signals transmitted from different ports are independent of each other, or where the signals do not maintain a fixed phase relationship. An example of non-coherent ports may include two antennas transmitting different data streams without any synchronization in their phase or amplitude, for instance due to the transmitter not controlling the relative phase of the signals transmitted by the different non-coherent ports. In contrast, coherent ports are those where the signals transmitted from the ports maintain a fixed phase relationship, or where the signals are synchronized in both phase and amplitude. An example of coherent ports may include two antennas transmitting the same data stream with a fixed phase offset, for instance due to the transmitter controlling the relative phase of the signals transmitted by the different antenna ports.

In scenarios where multiple DMRS ports are code division multiplexed (CDMed) and coherent, such as illustrated using port 0 and port 1 in FIG. 7, but only a single gRS port is transmitted, the observed channel at the gRS tone in the gRS symbol in one SLIV, slot or TTI may differ from that in the DMRS symbol at another SLIV, slot or TTI. This discrepancy may arise due to the inherent differences in the channel conditions observed by the gRS and DMRS symbols. Such channel differences observed between the gRS and DMRS may complicate the phase jump estimation process. For instance, unless the additional DMRS port(s) or channel(s) not used for transmission of gRS are accurately estimated and subsequently canceled, the receiver may experience difficulty estimating the phase jump 604 between the gRS 702 and DMRS. This task may become even more challenging under conditions of low signal-to-noise ratio (SNR) and tight receiver (Rx) processing timelines. Thus, inaccurate PDSCH or PUSCH decoding may also result.

For instance, in the example 700 of FIG. 7, multi-port DMRS may be applied using example ports 0 and 1, where at a k-th DMRS tone, the channel from the i-th port to the j-th receive (Rx) antenna may be denoted as H_{{i,j}}. For a two-port DMRS configuration, the received signals for the gRS 702 and DMRS 408 symbols may be expressed using different equations before and after the phase jump boundary. More particularly, for the single-port gRS symbol, the received signal may be yₖ=H_{{0,j}}·xₖ, where xₖ is the reference signal sequence of gRS and the gRS is transmitted from port 0, and for the multi-port DMRS symbol, the received signal is

$${y}_{k}^{′} = {e}^{\{ j Δθ \}} ( {H}_{\{ 0 , j \}} + {H}_{\{ 1 , j \}} ) \cdot {x}_{k}^{′} , where {x}_{k}^{′}$$

is another reference signal sequence of DMRS, the DMRS is transmitted from ports 0 and 1 using a (+1,+1) OCC at the gRS tone, and Δθ represents the phase difference or phase jump 604 between the two symbols. When multiple DMRS ports such as ports 0 and 1 of DMRS 408 in FIG. 7 are CDMed and non-coherent, the phase difference between these ports from slot to slot may not remain the same. In such cases, phase jump estimation would end up being performed independently for each port. However, in practical implementations, especially in the case where the base station is the transmitter, multiple DMRS ports are often implemented with coherent structures, mitigating this issue associated with non-coherency. Nevertheless, even when multiple coherent DMRS ports are used, the observed channel at the gRS tone in the gRS symbol at slot n−1 may still be different from that of the DMRS symbol at slot n if only a single gRS port is transmitted as in example 700 of FIG. 7. For instance, if only port 0 is used for gRS, the channel observed by the receiver will be H_{{0,j}}, whereas for DMRS, it would be a combination both ports' channels or H_{{0,j}}+H_{{1,j}} at the same tone used for gRS. This channel discrepancy may complicate the phase jump estimation, since the gRS is only affected by the channel from port 0 and thus does not experience the combined effect of both DMRS ports.

Likewise, while transmitting only one gRS port in a multi-port DMRS scenario may lead to inaccurate phase jump estimation, it may also complicate the PDSCH or PUSCH decoding process. For instance, if gRS is transmitted only from port 0 and noncausal DMRS combining is used for decoding the PDSCH at slot n−1, such as illustrated in FIG. 7, the receiver may delay the PDSCH decoding timeline until the DMRS in slot n is received. This delay may be incurred to allow for receiver estimation of H_{{1,j}}, so that the receiver may nullify this channel response from the received DMRS signal in slot n for accurate phase jump estimation. For instance, the receiver may estimate and then cancel H_{{1,j}} from the combined signal

$${e}^{\{ j Δ θ \}} ( {H}_{\{ 0 , j \}} + {H}_{\{ 1 , j \}} ) \cdot {x}_{k}^{′} ,$$

So that only the port 0 channel response may remain and match that of the gRS 702. However, this process may end up leading to the receiver performing two rounds of channel estimation: one to estimate H_{{1,j}} for the cancellation, and another to perform the phase jump estimation after nullifying H_{{1,j}}. This dual estimation process may be particularly problematic in low SNR scenarios, where the channel estimation of H_{{1,j}} may not be reliable from a single observation of the DMRS. Consequently, the phase jump estimation may be poor, leading to suboptimal decoding performance. Thus, it would be helpful to design a gRS that does not require additional channel estimation for phase jump estimation, particularly for advanced UE PUSCH transmission and PDSCH transmission and where coherent ports are used.

Aspects of the present disclosure accordingly provide a gRS that eliminates the need for extra channel estimation for phase jump estimation in a post-CDM fashion, where the gRS is CDMed to match a subsequent multi-port DMRS for non-causal combining or causal combining, thereby simplifying the process and improving performance. These aspects are particularly applicable for coherent ports used in PDSCH transmission or more advanced UE PUSCH transmission. By designing a gRS that inherently accounts for phase jumps without requiring additional channel estimation, the system may maintain phase continuity and optimize performance even in challenging conditions. For instance, a CDMed gRS may be used in conjunction with DMRS to determine the phase difference and combine the channel responses for proper decoding. By applying a CDM approach on the gRS to account for the multi-port nature of the DMRS, the receiver may consider multiple ports' channel impulse responses in the phase estimation process, allowing for accurate phase difference determination and proper decoding of the PDSCH or PUSCH. This approach may overcome the challenges previously described for accurately estimating the phase difference of a single-port gRS when the DMRS is multi-port. Additionally, while these aspects are specifically described to address the challenges associated with multi-port DMRS, particularly when the DMRS is present in adjacent slots n−1 and n and combined non-causally for PDSCH decoding in slot n−1, these aspects may similarly be extended and applied for causal combining and PDSCH decoding in slot n, PUSCH decoding, or for other reference signals than DMRS.

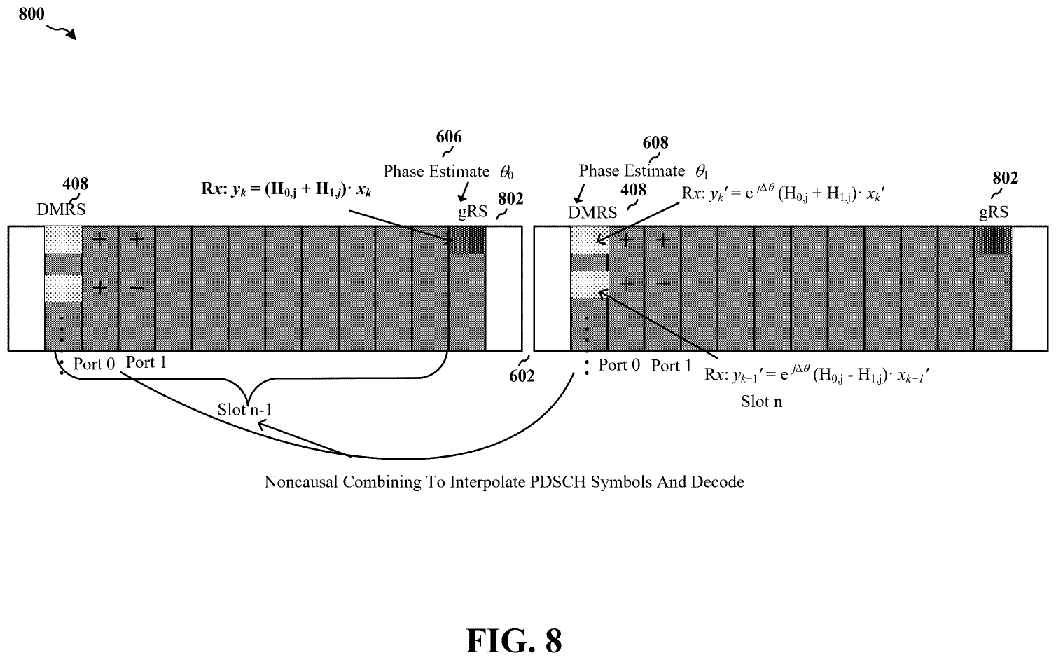

FIG. 8 illustrates an example 800 of a gRS 802 designed to apply in multi-port repetition for CDMed DMRS 408 ports. In one or more aspects, the gRS 802 may be associated with a DMRS RE in a post-CDM fashion, where the gRS 802 is CDMed to match the subsequent multi-port, DMRS 408 for non-causal combining or causal combining. For instance, when multiple CDM DMRS ports are coherent and gRS 802 is repeated previously across these multiple ports, such as port 0 and port 1 in the example of FIG. 8, the received signal at the k-th DMRS tone may be expressed as (H_{{0,j}}+H_{{1,j}})·xₖ for the gRS symbol in slot n−1 and

$${e}^{\{ j Δ θ \}} ( {H}_{\{ 0 , j \}} + {H}_{\{ 1 , j \}} ) \cdot {x}_{k}^{′}$$

for the corresponding DMRS symbol in slot n. This configuration allows the phase jump 604 to be estimated directly from the descrambled received signal without the need for per-port channel estimation first, in contrast to the example of FIG. 7. For instance, the receiver may calculate the phase difference between the gRS 802 and coherent, CDMed DMRS symbols and estimate the phase jump 40 directly from the received signals, facilitating accurate phase continuity and channel estimation. The receiver may then apply noncausal combining or causal combining to interpolate or extrapolate the PDSCH or PUSCH symbols and decode them accurately, such as previously described with respect to FIGS. 5A and 5B.

In this example 800, the gRS signal may repeated across the two CDM ports in a single tone. Thus, the gRS signal xₖ may be transmitted on the same tone over both port 0 and port 1, rather than only port 0 as in the prior example of FIG. 7. This repetition allows for the received signal to be affected by both DMRS ports' channels, resulting in the equivalent channel observed from the gRS being the same as that observed from the DMRS. Consequently, the only difference between the gRS and DMRS signals would be the phase jump Δθ, rather than both the phase jump and the channel response. This approach simplifies the phase jump estimation process compared to the single port gRS example of FIG. 7, as the channel conditions remain consistent across the gRS and DMRS symbols. This approach may be further extended to CDM configurations with more than two ports, enhancing the flexibility and scalability of the system.

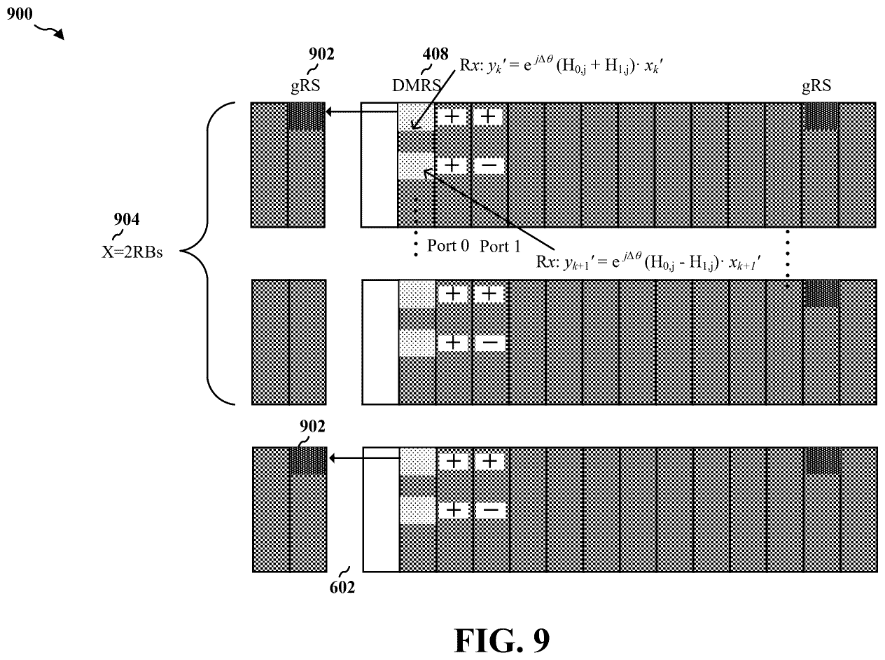

FIG. 9 illustrates another example 900 of a single tone, gRS 902 implemented for multi-port repetition in coherent CDMed DMRS 408 ports. Similar to the prior example, the gRS 902 may be transmitted in a post-CDM fashion for a group of coherent DMRS ports. The receiver may utilize the gRS 902 to effectively estimate the common phase jump for CDM coherent DMRS ports across physical or logical gaps such as gap 602. However, in contrast to the example of FIG. 8, the gRS 902 in this example may have a smaller overhead, occupying fewer REs. For example, gRS 902 may occupy 1/X reference signal resources for DMRS 408 having a length-X OCC. For instance, in the example of FIG. 9, X may be configured to be 2, and thus the gRS 902 may occupy half the resource blocks (RBs) used for DMRS. This reduction in overhead may be particularly beneficial for maintaining system efficiency and optimizing resource utilization.

In this example, the gRS tones may be configured as a subset 904 of DMRS tones or RBs, and the gRS 902 may be repeated over active DMRS ports in this subset 904. For instance, for every X RBs, such as 2 RBs in the example of FIG. 9, one RE occupied by the CDMed DMRS may be selected for transmission of gRS 902. This reduction in gRS resources by using the subset 904 of DMRS tones or RBs, such as 1/X of the length of the DMRS OCC, may help minimize overhead while maintaining effective phase jump estimation. For example, the gRS 902 density may be reduced to one RE every two RBs such as illustrated in FIG. 9, thereby reducing gRS overhead compared to the two REs every one RB which DMRS 408 uses in FIG. 9. Such transmission of gRS on a subset of DMRS tones or RBs may also allocate resources more effectively for data transmission.

This gRS 902 RE may be repeated in the same manner as the selected DMRS 408 RE, potentially with additional scrambling to ensure robustness. This repetition allows the gRS 902 to sound the same channel response as the CDMed DMRS ports, except for the phase jump 604. For instance, in the example of FIG. 9, the transmitter may repeat gRS 902 over active DMRS ports 0 and 1 by transmitting the gRS 902 orthogonally coded and code division multiplexed over each of these ports and corresponding to the (+1, +1) OCC of the DMRS 408 tone. The gRS may be transmitted over the same tone as the DMRS in a given slot.

The gRS 902 may be repeated on all active DMRS ports within the CDM group. For instance, if multiple CDM DMRS ports are transmitted, such as two frequency domain orthogonal cover code (FD-OCC) ports or four frequency domain plus time domain orthogonal cover code (FD+TD-OCC) ports, the transmitter may repeat the gRS on the transmitted CDM DMRS ports. Thus, if the CDM group includes two ports 0 and 1 for DMRS such as illustrated in FIG. 9, the gRS may be repeated on both port 0 and port 1 such as previously shown in and described with respect to FIG. 8. Alternatively, if the CDM group of the DMRS includes four ports, such as in configurations with both FD and TD-OCC, the gRS may be repeated on all four ports. For instance, if the ports used for DMRS includes ports 0, 1, 2, and 3, the channel response of gRS 902 may be configured to be H_{{0,j}}+H_{{1,j}}+H_{{2,j}}+H_{{3,j}}. The gRS may similarly be scaled to other numbers of ports. Here, in this example of FIG. 9 where DMRS are transmitted over two FD-OCC ports 0 and 1, gRS may similarly be repeated over the same ports 0 and 1. This repetition and mapping of the gRS transmission exactly to the active DMRS ports allows the gRS to capture the same channel responses as the CDMed DMRS ports other than the phase jump, maintaining consistency and accuracy in phase jump estimation.

This approach using gRS 902 shown in FIG. 9 is also different from typical uses of PTRS, which is limited to a single port and thus may not effectively estimate the phase jump in high Doppler scenarios. For instance, in contrast to a typical PTRS, where only one port of the PTRS is allowed to be non-zero on a given tone, gRS 902 may have multiple ports non-zero on a given tone. The transmitter may orthogonally code the gRS to account for these multiple ports. For instance, in the example of FIG. 9, if the subsequent slot's DMRS has a multi-port coherency with two FD-OCC ports transmitted on port 0 and port 1 with different orthogonal cover codes, the gRS in the prior slot may be multiplied by the current DMRS's tones' OCC, which is (+1, +1) in this example as it was in FIG. 8. This allows the gRS to capture the same channel responses as the DMRS, facilitating accurate phase jump estimation.

While in the example of FIG. 9, the prior slot's gRS and the subsequent slot's DMRS may be used together in noncausal combining for channel estimation similar to that of FIG. 8, in other examples, causal combining may be applied instead. Thus, aspects of the present disclosure may not be limited to non-causal combining but may also be extended to causal combining in present or future slots. The gRS may thus be used in either causal combining or non-causal combining scenarios in a post-CDM fashion, allowing for phase jump estimation based on DMRS in past or future slots, SLIVs, or other TTIs. For example, in either a non-causal combining approach or a causal combining approach, the gRS in one slot may be based on the DMRS in a subsequent slot, allowing for the phase jump estimation to remain accurate

The transmitter may select the gRS frequency locations for port repetition within REs in a CDM group. For instance, the base station may determine which REs to select for gRS transmission within every X RBs. Typically for PTRS, only the RE with a +1 OCC among all CDM ports is selected. However, this approach, while effective for typical PTRS implementations, may not be optimal for phase estimation purposes of gRS in 5G NR.

Accordingly, in various aspects, the transmitter may select the time and frequency resources of gRS 902 to be the subset 904 of the associated DMRS according to one of several alternatives for selecting these resources. In a first alternative, similar to PTRS, the gRS 902 may be picked from a subset of the DMRS tones or symbols with a +1 OCC, although naturally in a different symbol location than the DMRS 408. Thus, the gRS 902 may be picked from the subset 904 where the DMRS FD/TD-OCC for all the CDMed DMRS ports may be only +1 in one example. This approach is depicted in the example of FIG. 9, in which the gRS tones all are selected to match the DMRS tones associated with (+1, +1) OCC, but not other DMRS tone OCCs such as (+1, −1) OCC. In a second alternative, the gRS 902 may be picked from the subset 904 of DMRS tones or symbols where the DMRS FD/TD-OCC for all the CDMed DMRS ports may be either +1 or −1. For instance, referring to FIG. 9, in this alternative the gRS tones may be selected to match either, but not both, the DMRS tones associated with (+1, +1) OCC or (+1, −1) OCC, or whichever OCCs are applied for DMRS 408 in other examples. This approach provides greater adaptability in selecting the most suitable tones or symbols for gRS transmission, potentially improving the robustness and efficiency of the system. In a third alternative, the gRS may be picked from all M DMRS REs in a length-M OCC from the CDM DMRS.

For instance, referring to the example of FIG. 9 where M=2, in this alternative the gRS tones may be selected to match both, as opposed to only one of, the DMRS tones associated with (+1, +1) OCC and (+1, −1) OCC, thereby increasing the number of gRS compared to the other approaches. For instance, two gRS tones may be applied matching corresponding DMRS tones of length-2 OCC in this example, as opposed to the single gRS tone shown in FIG. 9. While this alternative ensures comprehensive coverage, it may result in M-times overhead compared to the other approaches, leading to increased resource consumption. Therefore, to mitigate this overhead, the frequency repetition density of gRS may be reduced, such that, for example, gRS may be transmitted every 2X-RBs while preserving the total number of gRS REs. For instance, in the example of FIG. 9, if this approach is used such that two gRS are transmitted in the same tones as the (+1, +1) OCC DMRS and the (+1, −1) OCC DMRS, the value of X may be doubled so that in this example the gRS may be transmitted every X=4 RBs instead of every 2 RBs. This approach thus allows the network to maintain the same total number of gRS REs as the other alternatives, thereby balancing coverage with resource efficiency.

Consequently, the gRS 902 may capture the same channel responses as the CDMed DMRS ports, facilitating accurate phase jump estimation. In any of the aforementioned alternatives, the transmitter may select the gRS tones as a subset of the DMRS tones or RBs and configure them such that the gRS tones are consistent with the OCC applied to the DMRS. For example, if the DMRS tones use a “+1” or “−1” OCC, the gRS tones may be configured to follow the same pattern so that the gRS captures the same channel responses as the DMRS. In this way, the gRS may effectively be used to estimate the common phase jump for CDM coherent DMRS ports across physical or logical gaps as previously described.

In another aspect, port repetition and scrambling of gRS in CDMed DMRS ports may be applied for phase jump estimation. In this aspect, the transmitter may repeat the gRS in active CDMed DMRS ports and apply a corresponding OCC for each active DMRS port. This approach allows the received gRS to experience the same frequency response as the DMRS across the phase jump boundary, except for the common phase jump.

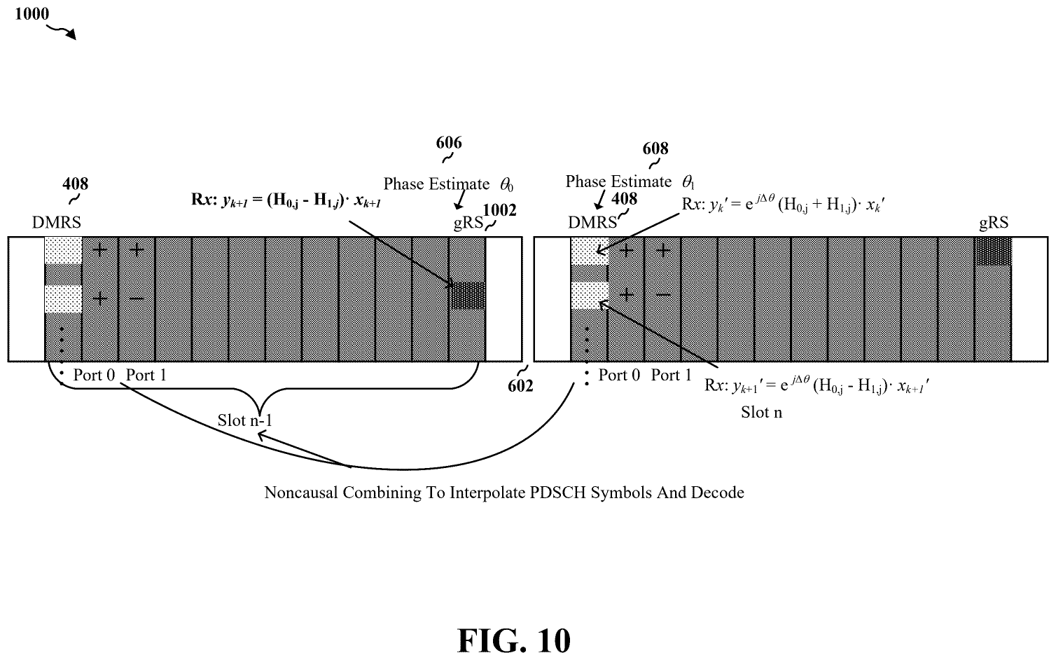

FIG. 10 illustrates an example 1000 of port repetition and scrambling of gRS 1002 in CDMed DMRS ports. In this example, the gRS 1002 may be placed at the k+1th DMRS tone location, and its reference signal sequence may be multiplied by an OCC of +1 for port 0 and an OCC of −1 for port 1. This multiplication allows the gRS to capture the same channel response as the DMRS, facilitating accurate phase jump estimation. More particularly, the received signal at the k+1-th DMRS tone for the gRS symbol may be expressed as yₖ₊₁=(H_{{0,j}}−H_{{1,j}})·xₖ₊₁, and for the corresponding DMRS symbol, it may be

$${y}_{k + 1}^{′} = {e}^{\{ j Δ θ \}} ( {H}_{\{ 0 , j \}} - {H}_{\{ 1 , j \}} ) \cdot {x}_{k + 1}^{′} .$$

This setup allows the gRS to sound the same channel response as the CDMed DMRS ports and thus the phase jump 40 to be estimated directly from the received signals, providing phase continuity and allowing for accurate channel estimation. After obtaining the phase estimates 606, 608 from both the gRS and DMRS symbols and determining the phase jump 604, the receiver may apply noncausal combining of the DMRS symbols in slot n−1 and n to interpolate the PDSCH symbols in slot n−1 and decode them accurately. Alternatively, the receiver may apply causal combining to extrapolate the PDSCH symbols in slot n and decode them accurately.

While the aforementioned aspects allow the transmitter to strategically place gRSs within REs and RBs for phase jump estimation, it is also important to optimize frequency diversity in the placement of these gRSs. For instance, if the transmitter only picks the DMRS tones where the OCC is consistently +1 for gRS, the frequency diversity may not be sufficient, especially if the channel response H is flat. For example, in some instances, the combined channel response H_{{0,j}}+H_{{1,j}} may be close to zero, leading to suboptimal performance. Thus, it would be helpful to allow gRS tones to be selected in a manner that maximizes frequency diversity and that effectively captures the channel response across different CDMed DMRS ports.

To harvest multiport gRS gain in scenarios where the combined channel response is flat or where frequency diversity would otherwise be desired, the transmitter may alternate the selection of gRS tones or symbols between tones associated with different OCCs, such as those with +1 and those with both +1 and −1 in a length-two OCC. More generally, for a multi-port DMRS with a length N OCC, gRSs may be alternatingly placed at RE index ‘k modulus N’ in one RB, at RE index ‘k+1 modulus N’ in another RB, and so forth up to RE index ‘k+ (N−1) modulus N’ in an Nth RB, repeating similarly for k>=0. Thus, for a length two OCC, the gRSs in slot n−1 of FIG. 10 may be placed such that one gRS is transmitted at the DMRS tone having a (+1, +1) OCC in a k modulus 2^{nd} RE, and another gRS may be transmitted at the DMRS tone having a (+1, −1) OCC in a k+1 modulus 2^{nd} RE, repeating similarly for k>=0. Stated another way, gRSs may be for example placed in tones corresponding to different OCCs of CDMed DMRS every even RE and every odd RE, respectively, or in other REs depending on the OCC length. This approach allows the gRS captures a more diverse set of channel responses, enhancing the robustness and accuracy of phase jump estimation.

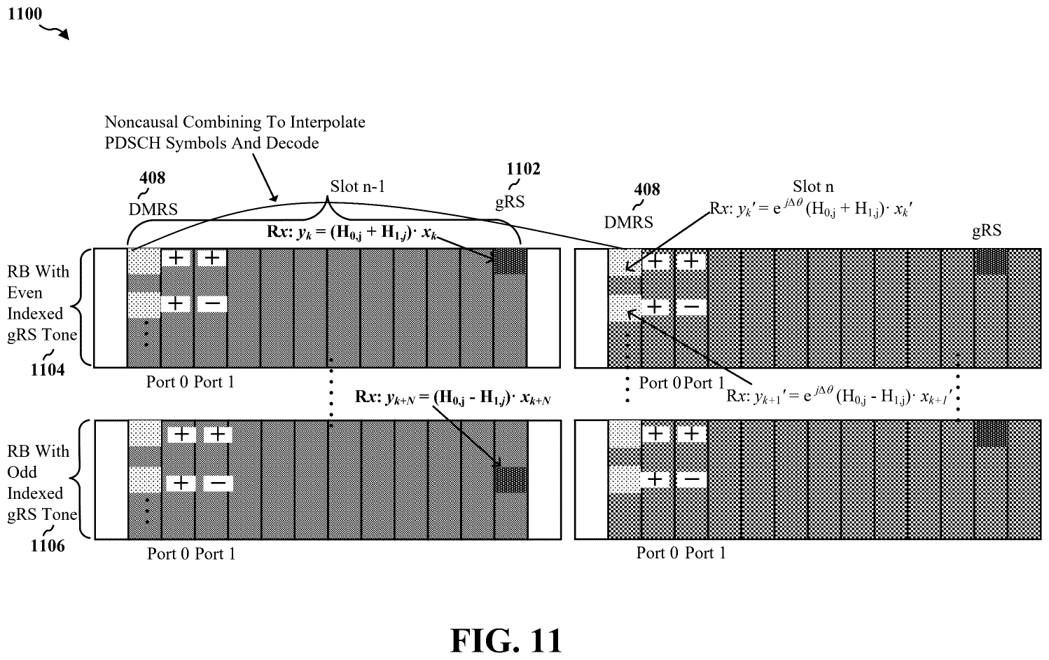

FIG. 11 illustrates an example 1100 of gRS 1102 repetition in alternating, even tones 1104 and odd tones 1106 to achieve frequency diversity and multiport gRS gain harvesting. In one example, for even-indexed gRS tones 1104, the transmitter may pick the DMRS tone or symbol location where all the CDM DMRS ports have a +1 OCC. For instance, after gRS port repetition, all the gRS ports in these even-indexed tones may be multiplied by an OCC of +1. For example, the received signal at the k-th DMRS tone for the gRS 1102 symbol in even-indexed tones 1104 may be expressed as yₖ=(H_{{0,j}}+H_{{1,j}})·xₖ, and for the corresponding DMRS 408 symbol, it may be

$${y}_{k}^{′} = {e}^{\{ j Δ θ \}} ( {H}_{\{ 0 , j \}} + {H}_{\{ 1 , j \}} ) \cdot {x}_{k}^{′} .$$

This allows the gRS 1102 to capture the same channel response H_{{0,j}}+H_{{1,j}} as the DMRS 408 in these tones, facilitating accurate phase jump estimation. In contrast, for odd-indexed gRS tones 1106, the transmitter may select DMRS tones or symbols with a different OCC, such as where the CDMed DMRS ports have both +1 and −1 OCC, and the transmitter may apply the corresponding OCC per gRS port. For example, after gRS port repetition, the transmitter may multiply all the gRS ports by the corresponding +1 or −1 OCC. Thus, the received signal at the k+1th DMRS tone for the gRS symbol in odd-indexed tones 1106 in the Nth RB may be expressed as y_{k+N}=(H_{{0,j}}−H_{{1,j}})·x_{K+N}, and for the corresponding DMRS 408 symbol, it may be

$${y}_{k + N}^{′} = {e}^{\{ j Δ θ \}} ( {H}_{\{ 0 , j \}} - {H}_{\{ 1 , j \}} ) \cdot {x}_{k + 1 + N}^{′} .$$

This allows the gRS 1102 to capture the channel response H_{{0,j}}−H_{{1,j}} for odd-indexed tones 1106, providing additional channel diversity. Afterwards, the receiver may apply noncausal combining such as illustrated in FIG. 11, or causal combining in other examples, to respectively interpolate or extrapolate the PDSCH symbols and decode them accordingly.

While the illustrated example specifically references even and odd gRS mapping patterns, other patterns may be applied depending on the DMRS pattern to maximize frequency diversity. For instance, the aforementioned alternation of gRS 1102 across two CDMed DMRS ports may be extended to scenarios involving longer OCC sequences, such as a length four FD-OCC. In such cases, instead of alternating the gRS tone between two indices corresponding to a length-2 OCC such as illustrated in FIG. 11, the gRS tones may be distributed across four indices corresponding to a length-4 OCC. For example, the gRS tones in FIG. 11 may be placed at the DMRS tone having a (+1, +1, +1, +1) OCC in a k modulus 4^{th} RE, at the DMRS tone having a (+1, −1, +1, −1) OCC in a k+1 modulus 4^{th} RE, at the DMRS tone having a (+1, −1, −1, +1) OCC in a k+2 modulus 4^{th} RE, and at the DMRS tone having a (−1, −1, −1, −1) OCC in a k+3 modulus 4^{th} RE, repeating similarly for k>=0. Other OCCs, OCC lengths, and mapping patterns may be used in other examples. This approach allows for the gRS 1102 to capture the channel responses across the entire OCC sequence, providing comprehensive frequency diversity and robust phase jump estimation. Thus, by adopting a gRS pattern which alternates across different CDMed DMRS ports depending on OCC length, frequency diversity may be achieved with the gRS 1102 capturing a comprehensive set of channel responses. For instance, in the illustrated example of FIG. 11, the even-indexed gRS may capture the channel response H_{{0,j}}+H_{{1,j}}, while the odd-indexed gRS may capture the channel response H_{{0,j}}−H_{{1,j}}. The strategic placement of gRS tones within RBs, alternating between different OCCs, allows the gRS to capture a diverse set of channel responses. This approach is particularly helpful in scenarios where the channel response H is flat, as it mitigates the risk of the combined channel response H_{{0,j}}+H_{{1,j}} being effectively zero due to H_{{0,j}} being positive and H_{{1,j}} being negative or vice-versa, or of the channel responses H_{{0,j}} and H_{{1,j}} otherwise cancelling each other out. More generally, by alternating the gRS tones between different OCC combinations, such as (+1, +1) and (+1, −1), the transmitter may ensure that if one channel response combination is insufficient for phase estimation purposes, the other channel response combination may be able to compensate for it. Thus, multiport gRS gain may effectively be harvested, enhancing overall performance. For instance, the transmitter may still be able to estimate the phase jump 40 directly from the received signals, ensuring phase continuity and accurate channel estimation.

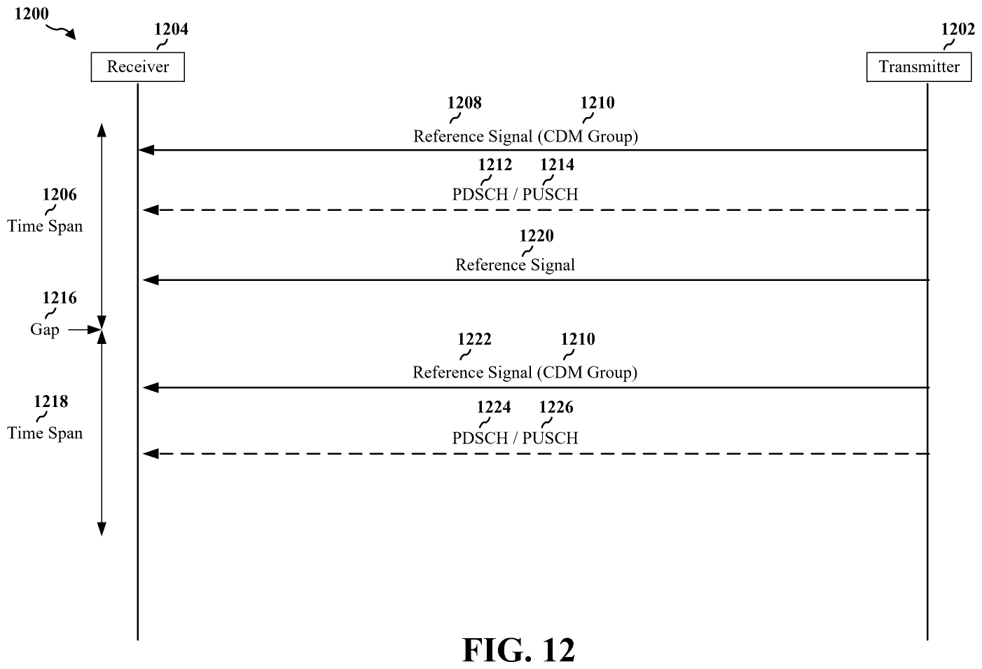

FIG. 12 illustrates an example 1200 of a call flow between a transmitter 1202 and a receiver 1204. In one example, the transmitter 1202 may correspond to base station 102/180, disaggregated base station 181, a component of disaggregated base station 181 such as CU 183, DU 185, or RU 187, or other network entity, and the receiver 1204 may correspond to UE 104. In another example, the transmitter 1202 may correspond to UE 104, and the receiver 1204 may correspond to base station 102/180, disaggregated base station 181, a component of disaggregated base station 181 such as CU 183, DU 185, or RU 187, or other network entity. In this example 1200, a communication process between transmitter 1202 and receiver 1204 is depicted, illustrating the exchange of reference signals and data channels across time spans with a physical or logical gap in between the time spans.

Initially, during a first time span 1206, the transmitter 1202 may send, and the receiver 1204 may obtain, a first reference signal 1208 associated with multiple coherent ports in a CDM group 1210. The first time span 1206 may correspond to a first TTI, SLIV, or slot such as slot n−1 in FIG. 8. In one example, this first reference signal 1208 may be a DMRS used for channel estimation, which may be configured for the receiver to accurately interpret incoming data signals. For instance, the DMRS may be transmitted from multiple ports in the CDM group 1210 at the beginning of slot n−1 with a length-2 OCC including a (+1, +1) OCC for one DMRS tone and a (+1, −1) OCC for another DMRS tone, such as illustrated and described with respect to FIG. 8. During this first time span, the transmitter 1202 may also send data on a PDSCH 1212 or PUSCH 1214, depending on the direction of communication, which the receiver 1204 may buffer for subsequent decoding.

A gap 1216 may exist between the first time span 1206 and a second time span 1218 subsequent to the first time span 1206. The second time span 1218 may correspond to another TTI, SLIV, or slot such as slot n in FIG. 8. The gap 1216 may introduce phase discontinuities or other challenges to communication integrity. For instance, phase jump 604 may exist across gap 1216, which in high Doppler scenarios, may be challenging to consider during PDSCH or PUSCH decoding using only first reference signal 1208 and another reference signal during second time span 1218.

Accordingly, to compensate for phase changes across the gap 1216, the transmitter 1202 may send, and the receiver 1204 may obtain, a second reference signal 1220 in the first time span 1206. The second reference signal 1220 may be specifically configured to handle phase changes that occur across the gap 1216, so that the receiver may maintain accurate channel estimation despite the discontinuity. For instance, the second reference signal 1220 may be a gRS that is implemented from a PTRS or other reference signal, and which is transmitted in a post-CDM fashion over multiple ports from at least a single tone corresponding to that of a DMRS such as illustrated and described with respect to FIGS. 9-11.

After the gap 1216, during the second time span 1218, the transmitter 1202 may send, and the receiver 1204 may obtain, a third reference signal 1222 associated with multiple coherent ports in the same CDM group 1210 as the first reference signal 1208. In one example, this third reference signal 1222 may be another DMRS used for joint channel estimation with first reference signal 1208, both of which may be configured for the receiver to accurately interpret the incoming signals. For instance, the DMRS may be transmitted from multiple ports in the CDM group at the beginning of slot n with a length-2 OCC including a (+1, +1) OCC for one DMRS tone and a (+1, −1) OCC for another DMRS tone, such as illustrated and described with respect to FIG. 8.

After receiving the reference signals 1208, 1220, 1222, the receiver 1204 may adjust its channel estimation to account for phase discontinuities during noncausal or causal combining, allowing for accurate data decoding in PDSCH or PUSCH. This may be particularly important in high Doppler scenarios where rapid movement may cause significant phase shifts. For instance, during the first time span 1206, the transmitter 1202 may send data on PDSCH 1212 or PUSCH 1214, depending on the direction of communication. This data transmission may be facilitated by accurate channel estimation provided by at least the second reference signal 1208. For instance, after accounting for the phase jump over gap 1216 based on second reference signal 1208, the receiver 1204 may use the first reference signal 1208 and the third reference signal 1222 during non-causal combining to estimate the channels associated with the DMRS and decode the PDSCH 1212 or PUSCH 1214. Similarly, the transmitter 1202 may also or alternatively send data on a PDSCH 1224 or PUSCH 1226 during the second time span 1218, depending on the direction of communication. This data transmission may be facilitated by accurate channel estimation provided by at least the second reference signal 1208. For instance, after accounting for the phase jump over gap 1216 based on second reference signal 1208, the receiver 1204 may use the first reference signal 1208 and the third reference signal 1222 during causal combining to estimate the channels associated with the DMRS and decode the PDSCH 1224 or PUSCH 1226.

The second reference signal 1220 may be specifically configured to handle phase changes that occur across the gap 1216, so that the receiver may maintain accurate channel estimation despite the discontinuity. In one example, the second reference signal 1220 may be placed within specific subcarriers and resource blocks to optimize resource utilization and minimize overhead. For instance, the second reference signal 1220 may be configured, transmitted, and received in a single subcarrier within each of multiple RBs, which RBs may be spaced apart for example by every Xth RB to reduce overhead such as illustrated in FIG. 9. In another example serving as an alternative to FIG. 9, the second reference signal 1220 may be received in M subcarriers respectively within each of multiple RBs, where M is the OCC length for the first reference signal 1208, and the multiple RBs include each 2Xth RB in the plurality of RBs, where X≥2. In a further example, the second reference signal 1220 may be repeated over the multiple coherent ports associated with the first reference signal 1208 in the single subcarrier within each of these multiple RBs, and the second reference signal 1220 may be applied with an OCC associated with each of the multiple coherent ports for the third reference signal 1222 such as illustrated in FIG. 10. In an additional example, the second reference signal 1220 may be received in a single subcarrier within each of a plurality of RBs, which includes a first set of inconsecutive RBs and a second set of inconsecutive RBs. The subset may include subcarriers in the first set with positive OCCs and in the second set with both positive and negative OCCs such as illustrated in FIG. 11.

In one example, the first set of inconsecutive RBs may include even indexed subcarriers for the second reference signal 1220, and the second set of inconsecutive RBs may include odd indexed subcarriers for the second reference signal 1220, such as illustrated in FIG. 11. More particularly, the second reference signal 1220 in the first set of inconsecutive RBs may be applied with the positive OCC associated with each of the multiple coherent ports for the first reference signal 1208 or the third reference signal 1222, and the second reference signal 1220 in the second set of inconsecutive RBs may be applied with the positive OCC and the negative OCC respectively associated with the multiple coherent ports for the first reference signal 1208 or third reference signal 1222. In other examples, the sets of inconsecutive RBs may respectively include different indexed subcarriers for the second reference signal 1220 than even or odd, such as k+(N−1) modulus N indexed subcarriers for a length N OCC associated with the multiple coherent ports for the first reference signal 1208 or third reference signal 1222.

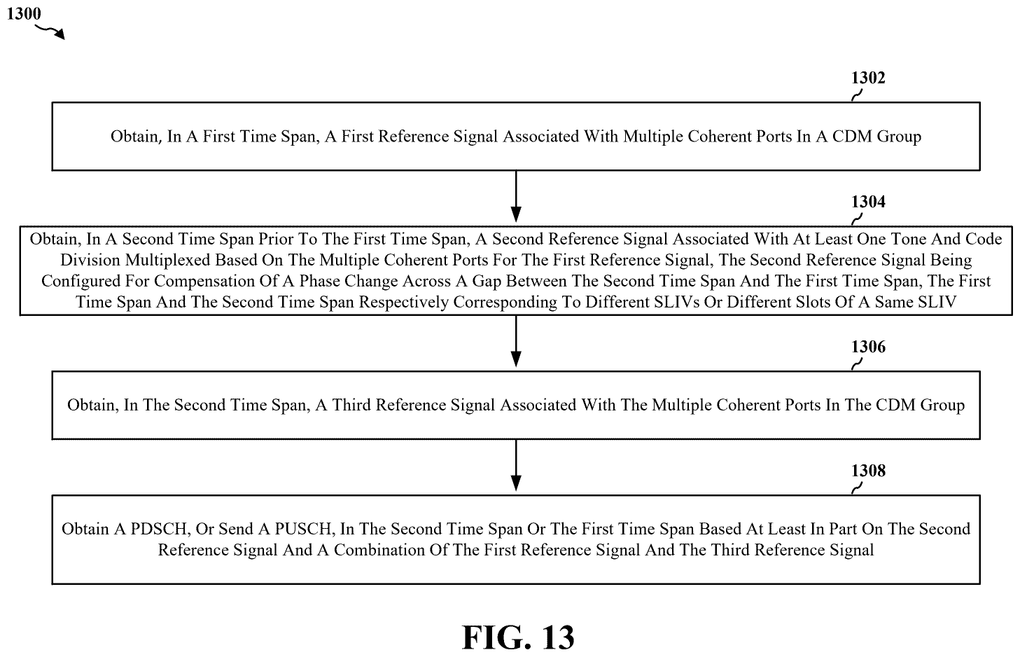

FIG. 13 is a flowchart 1300 of a method of wireless communication. The method may be performed by a UE or one or more of its components, for example, the UE 104, 350; one or more of RX processor(s) 356, TX processor(s) 368, or controller(s)/processor(s) 359; the apparatus 1502; or cellular baseband processor(s) 1504 or its components. The method allows a UE to maintain phase continuity and optimize channel estimation by utilizing a gRS. This involves obtaining multiple reference signals across different time spans, including a first reference signal, a second reference signal configured for compensation of phase changes, and a third reference signal. By combining these reference signals and applying causal or non-causal combining techniques, the UE can effectively decode PDSCH or send PUSCH even in the presence of phase jumps or gain changes, thereby improving overall communication performance and efficiency.

At block 1302, the UE may obtain, in a first time span, a first reference signal associated with multiple coherent ports in a CDM group. For example, block 1302 may be performed by reference signal component 1540. Obtaining the first reference signal may include, for example, receiving, demodulating, and decoding an encoded and modulated signal including the first reference signal using one or more of RX processor(s) 356 or controller(s)/processor(s) 359 such as described with respect to UE 350 in FIG. 3. For instance, referring to the Figures, the base station 102/180 or transmitter 1202 may send, and UE 104, 350 or receiver 1204 may obtain, reference signal 1222 in time span 1218. For instance, reference signal 1222 may correspond to DMRS 408 in slot n in FIG. 8. Reference signal 1222 may be sent and obtained over multiple coherent ports in CDM group 1210. For example, DMRS 408 in slot n may be transmitted and received over ports 0 and 1 with different OCCs such as illustrated in FIG. 8.

At block 1304, the UE may obtain, in a second time span prior to the first time span, a second reference signal associated with at least one tone and code division multiplexed based on the multiple coherent ports for the first reference signal, the second reference signal being configured for compensation of a phase change across a gap between the second time span and the first time span, the first time span and the second time span respectively corresponding to different SLIVs or different slots of a same SLIV. For example, block 1304 may be performed by reference signal component 1540. Obtaining the second reference signal may include, for example, receiving, demodulating, and decoding an encoded and modulated signal including the second reference signal using one or more of RX processor(s) 356 or controller(s)/processor(s) 359 such as described with respect to UE 350 in FIG. 3. For instance, referring to the Figures, the base station 102/180 or transmitter 1202 may send, and UE 104, 350 or receiver 1204 may obtain, reference signal 1220 in time span 1206 prior to time span 1218. For instance, reference signal 1220 may correspond to gRS 802, 902, 1002, or 1102 in slot n−1 in any of FIGS. 8-11. Time span 1206 may be in a same SLIV as time span 1218. For example, at least a portion of slot n−1 and slot n of FIG. 8 may be together within one of the long 11-symbol, SLIVs 406 illustrated in the example of FIG. 4. Alternatively, time span 1206 may be in a different SLIV than time span 1218. For example, slot n−1 of FIG. 8 may include one of the short 4-symbol, SLIVs 406 illustrated in the example of FIG. 4, while slot n of FIG. 8 may include a different one of the short 4-symbol, SLIVs 406 illustrated in the example of FIG. 4. Reference signal 1220 may be sent and obtained over a single tone or subcarrier and orthogonally cover coded according to the OCCs corresponding to the multiple coherent ports of reference signal 1222 in CDM group 1210. For example, gRS 802, 902, 1002, or 1102 in slot n−1 may be transmitted and received over one subcarrier and orthogonally coded to have the same channel response as a multi-port DMRS 408 transmitted and received in the same frequency tone but in a different symbol in slot n, such as illustrated in any of FIGS. 8-11. This gRS 802, 902, 1002, or 1102 may be configured in a last symbol of the PDSCH or PUSCH in slot n−1 or otherwise close to or adjacent to the gap 602, 1216 between time spans 1206, 1218 or slots n−1 and n, such as illustrated in any of FIGS. 8-11. Such placement near gap 602 allows the UE or base station to determine the phase jump 604 across gap 602 from respective phase estimates 606, 608 of the gRS and DMRS even in high Doppler scenarios, so that the UE or base station may compensate for this phase jump when it performs joint channel estimation of the reference signals 1208 and 1222 and thereby accurately decode PDSCH 1212, 1224 or PUSCH 1214, 1226.

At block 1306, the UE may obtain, in the second time span, a third reference signal associated with the multiple coherent ports in the CDM group. For example, block 1306 may be performed by reference signal component 1540. Obtaining the third reference signal may include, for example, receiving, demodulating, and decoding an encoded and modulated signal including the third reference signal using one or more of RX processor(s) 356 or controller(s)/processor(s) 359 such as described with respect to UE 350 in FIG. 3. For instance, referring to the Figures, the base station 102/180 or transmitter 1202 may send, and UE 104, 350 or receiver 1204 may obtain, reference signal 1208 in time span 1206. For instance, reference signal 1208 may correspond to DMRS 408 in slot n−1 in FIG. 8. Reference signal 1208 may be sent and obtained over multiple coherent ports in CDM group 1210. For example, DMRS 408 in slot n−1 may be transmitted and received over ports 0 and 1 with different OCCs such as illustrated in FIG. 8, with the different OCCs corresponding to ports 0 and 1 respectively matching the OCCs of the DMRS 408 in slot n.

At block 1308, the UE may obtain a PDSCH, or send a PUSCH, in the second time span or the first time span based at least in part on the second reference signal and a combination of the first reference signal and the third reference signal. For example, block 1308 may be performed by data component 1542. Obtaining the PDSCH may include, for example, receiving, demodulating, and decoding an encoded and modulated signal including the PDSCH using one or more of RX processor(s) 356 or controller(s)/processor(s) 359 such as described with respect to UE 350 in FIG. 3. Sending the PUSCH may include, for example, encoding, modulating, and transmitting the PUSCH using one or more of TX processor(s) 368 or controller(s)/processor(s) 359 such as described with respect to UE 350 in FIG. 3. For instance, referring to the Figures, the base station 102/180 or transmitter 1202 may send and UE 104, 350 or receiver 1204 may obtain PDSCH 1212, 1224, or the base station 102/180 or transmitter 1202 may obtain and UE 104, 350 or receiver 1204 may send PUSCH 1214, 1226. The PDSCH 1212 or PUSCH 1214 may be sent or obtained in time span 1206, while the PDSCH 1224 or PUSCH 1226 may be sent or obtained in time span 1218. The UE may obtain PDSCH 1212 or send PUSCH 1214 in response to the UE or base station respectively applying noncausal combining of reference signals 1208 and 1222, such as DMRS 408 in slots n−1 and n, while accounting for the phase jump 604 derived using reference signal 1220, such as gRS 802, 902, 1002, or 1102 in slot n−1. Alternatively, the UE may obtain PDSCH 1224 or send PUSCH 1226 in response to the UE or base station respectively applying causal combining of reference signals 1208 and 1222, such as DMRS 408 in slots n−1 and n, while accounting for the phase jump 604 derived using reference signal 1220, such as gRS 802, 902, 1002, or 1102 in slot n−1.

In one example, the second reference signal may be received in a single subcarrier within each of multiple RBs of a plurality of RBs. More particularly, in one example, the multiple RBs may include each Xth RB in the plurality of RBs, where X≥2. For instance, referring to FIG. 9, the base station 102/180, 310 or transmitter 1202 may send, and the UE 104, 350 or receiver 1204 may receive, gRS 902 in the subcarrier corresponding to one of the DMRS 408 tones in one of every X RBs, such as every second RB in this example shown in FIG. 9.

In one example, the second reference signal may be repeated over the multiple coherent ports associated with the first reference signal in the single subcarrier within the each of the multiple RBs. For instance, referring to FIGS. 8 and 9, the base station 102/180, 310 or transmitter 1202 may send, and the UE 104, 350 or receiver 1204 may receive, repetitions of gRS 802, 902 over the ports 0 and 1 from which DMRS 408 is sent in slot n, resulting in the gRS having the same channel response as the corresponding DMRS such as H0,j+H1,j in this example, excluding phase jump 604. The gRS 902 may be sent and received in the subcarrier corresponding to this DMRS 408 in one of every X RBs, such as every other RB in this example.

In one example, the second reference signal may be applied with an orthogonal cover code associated with each of the multiple coherent ports for the first reference signal. For instance, referring to FIGS. 8-10, the base station 102/180, 310 or transmitter 1202 may send, and the UE 104, 350 or receiver 1204 may receive, repetitions of gRS 802, 902, 1002 using the same OCC for which DMRS 408 is coded in slot n, resulting in the gRS having the same channel response as the corresponding DMRS. For instance, if the DMRS sent over ports 0 and 1 in one subcarrier uses an OCC of (+1, −1) such that its channel response is H0,j−H1,j in this example, the gRS may similarly apply that OCC to result in a same channel response of H0,j−H1,j such as illustrated in FIG. 10, excluding phase jump 604. The gRS 902 may be sent and received in the subcarrier corresponding to this DMRS 408 in one of every X RBs, such as every other RB in this example.

In one example, the single subcarriers in each of the multiple RBs may together comprise a subset of a set of subcarriers for the first reference signal. For instance, referring to FIGS. 9 and 10, the base station 102/180, 310 or transmitter 1202 may send, and the UE 104, 350 or receiver 1204 may receive, gRS 902, 1002 in the subcarrier corresponding to one of the DMRS 408 tones in one of every X RBs, such as every second RB in this example shown in FIG. 9. This subcarrier for gRS 902, 1002 may be a subset of the subcarriers used for DMRS 408, such as one of the two subcarriers applied for DMRS 408 in every second RB in FIGS. 9 and 10.

In one example, the subset may include subcarriers where the multiple coherent ports for the first reference signal are each associated with a positive orthogonal cover code. For instance, referring to FIG. 9, the base station 102/180, 310 or transmitter 1202 may send, and the UE 104, 350 or receiver 1204 may receive, gRS 902 in the subcarrier corresponding to one of the DMRS 408 tones in one of every X RBs, such as every second RB in this example shown in FIG. 9. This subcarrier for gRS 902 may be a subset of the subcarriers used for DMRS 408 which is applied with a positive OCC, such as the one of the two subcarriers applied for DMRS 408 in every second RB illustrated in FIG. 9. Here, a positive OCC is one which only includes positive signs, such as (+1, +1) in the example of FIG. 9.

In one example, the subset may include subcarriers where the multiple coherent ports for the first reference signal are each associated with either a positive orthogonal cover code or a negative orthogonal cover code. For instance, referring to FIGS. 9 and 10, the base station 102/180, 310 or transmitter 1202 may send, and the UE 104, 350 or receiver 1204 may receive, gRS 902, 1002 in the subcarrier corresponding to one of the DMRS 408 tones in one of every X RBs, such as every second RB in this example shown in FIG. 9. This subcarrier for gRS 902, 1002 may be a subset of the subcarriers used for DMRS 408 which is applied with a positive OCC or a negative OCC, such as the one of the two subcarriers applied for DMRS 408 in every second RB illustrated in FIG. 9 or FIG. 10. Here, a positive OCC is one which only includes positive signs, such as (+1, +1) in the example of FIG. 9, while a negative OCC is one which includes at least one negative sign, such as (+1, −1) in the example of FIG. 10.

In one example, the second reference signal is received in M subcarriers respectively within each of multiple resource blocks (RBs) of a plurality of RBs, the M subcarriers in each of the multiple RBs together comprise a subset of a set of subcarriers for the first reference signal, M is an orthogonal cover code length for the first reference signal, and the multiple RBs include each 2X^{th} RB in the plurality of RBs, where X≥2. For instance, referring to FIGS. 9 and 10, the base station 102/180, 310 or transmitter 1202 may send, and the UE 104, 350 or receiver 1204 may receive, gRS 902, 1002 in the subcarrier corresponding to M of the DMRS 408 tones in one of every 2X RBs, such as both DMRS tones in every fourth RB in an alternative of the example shown in FIG. 9 where X=2. These M subcarrier for gRS 902, 1002 may be a subset of the subcarriers used in total for DMRS 408, such as half of all subcarriers applied in total for DMRS 408 across all RBs in the alternative example of FIG. 9. In the examples of FIGS. 9 and 10, M may be two such that the DMRS 408 has a length-2 OCC corresponding to ports 0 and 1, although M may be different in other examples.

In various examples, the second reference signal may be received in a single subcarrier within each of a plurality of RBs, the plurality of RBs includes a first set of inconsecutive RBs and a second set of inconsecutive RBs, the single subcarriers in each of the plurality of RBs together comprise a subset of a set of subcarriers for the first reference signal, the subset including subcarriers in the first set of inconsecutive RBs where the multiple coherent ports for the first reference signal are each associated with a positive orthogonal cover code, and the subset including subcarriers in the second set of inconsecutive RBs where the multiple coherent ports for the first reference signal are respectively associated with a negative orthogonal cover code. In one of these examples, the first set of inconsecutive RBs may include even indexed subcarriers for the second reference signal, and the second set of inconsecutive RBs may include odd indexed subcarriers for the second reference signal. In another of these examples, the second reference signal in the first set of inconsecutive RBs may be applied with the positive orthogonal cover code associated with each of the multiple coherent ports for the first reference signal, and the second reference signal in the second set of inconsecutive RBs may be applied with the negative orthogonal cover code respectively associated with the multiple coherent ports for the first reference signal. For instance, referring to FIG. 11, the base station 102/180, 310 or transmitter 1202 may send, and the UE 104, 350 or receiver 1204 may receive, gRS 1102 in a subcarrier corresponding to one of the DMRS 408 tones in each of a plurality of RBs, such as an even-indexed subcarrier and an odd-indexed subcarrier respectively in at least two RBs in the example shown in FIG. 11. This subcarrier for gRS 902, 1002 may be a subset of the subcarriers used for DMRS 408, such as every even subcarrier corresponding to a DMRS tone which is applied with a positive OCC and every odd subcarrier corresponding to a DMRS tone which is applied with a negative OCC, such as illustrated in FIG. 11. The even and odd subcarriers may be alternatingly applied in different RBs such as illustrated in FIG. 11, such that gRS 1102 in one set of inconsecutive RBs including every even RB applies a positive OCC while gRS 1102 in another set of inconsecutive RBs including every odd RB applies a negative OCC, again such as illustrated in FIG. 11. Here, a positive OCC is one which only includes positive signs, such as (+1, +1) in the example of FIG. 11, while a negative OCC is one which includes at least one negative sign, such as (+1, −1) in the example of FIG. 11.

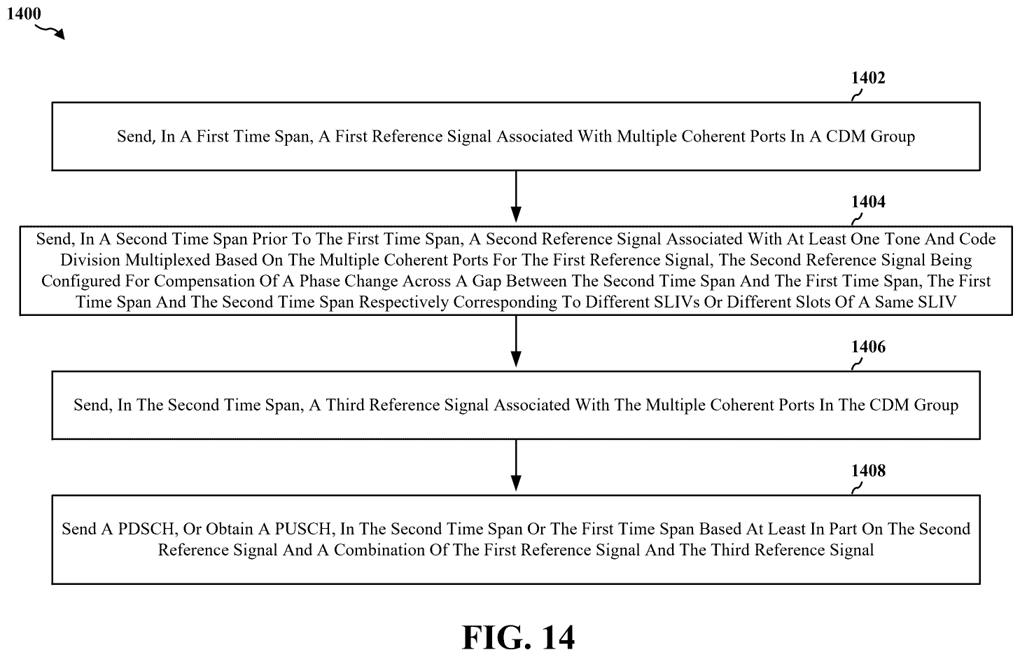

FIG. 14 is a flowchart 1400 of a method of wireless communication. The method may be performed by a network entity such as a base station or one or more of its components, for example, the base station 102/180, 310; disaggregated base station 181 or one or more of its components; one or more of RX processor(s) 370, TX processor(s) 316, or controller(s)/processor(s) 375; the apparatus 1602; or baseband unit(s) 1604 or its components. The method allows a network entity to maintain phase continuity and optimize channel estimation by utilizing a gRS. This involves sending multiple reference signals across different time spans, including a first reference signal, a second reference signal configured for compensation of phase changes, and a third reference signal. By combining these reference signals and applying causal or non-causal combining techniques, the network entity can effectively manage PDSCH or receive PUSCH even in the presence of phase jumps or gain changes, thereby improving overall communication performance and efficiency.

At block 1402, the network entity may send, in a first time span, a first reference signal associated with multiple coherent ports in a CDM group. For example, block 1402 may be performed by reference signal component 1640. Sending the first reference signal may include, for example, transmitting, modulating, and encoding the first reference signal using one or more of the TX processor(s) 316 or controller(s)/processor(s) 375, such as described with respect to BS 310 in FIG. 3. For instance, referring to the Figures, the base station 102/180 or transmitter 1202 may send, and UE 104, 350 or receiver 1204 may obtain, reference signal 1222 in time span 1218. For instance, reference signal 1222 may correspond to DMRS 408 in slot n in FIG. 8. Reference signal 1222 may be sent and obtained over multiple coherent ports in CDM group 1210. For example, DMRS 408 in slot n may be transmitted and received over ports 0 and 1 with different OCCs such as illustrated in FIG. 8.

At block 1404, the network entity may send, in a second time span prior to the first time span, a second reference signal associated with at least one tone and code division multiplexed based on the multiple coherent ports for the first reference signal, the second reference signal being configured for compensation of a phase change across a gap between the second time span and the first time span, the first time span and the second time span respectively corresponding to different SLIVs or different slots of a same SLIV. For example, block 1404 may be performed by reference signal component 1640. Sending the second reference signal may include, for example, transmitting, modulating, and encoding the second reference signal using one or more of the TX processor(s) 316 or controller(s)/processor(s) 375, such as described with respect to BS 310 in FIG. 3. For instance, referring to the Figures, the base station 102/180 or transmitter 1202 may send, and UE 104, 350 or receiver 1204 may obtain, reference signal 1220 in time span 1206 prior to time span 1218. For instance, reference signal 1220 may correspond to gRS 802, 902, 1002, or 1102 in slot n−1 in any of FIGS. 8-11. Time span 1206 may be in a same SLIV as time span 1218. For example, at least a portion of slot n−1 and slot n of FIG. 8 may be together within one of the long 11-symbol, SLIVs 406 illustrated in the example of FIG. 4. Alternatively, time span 1206 may be in a different SLIV than time span 1218. For example, slot n−1 of FIG. 8 may include one of the short 4-symbol, SLIVs 406 illustrated in the example of FIG. 4, while slot n of FIG. 8 may include a different one of the short 4-symbol, SLIVs 406 illustrated in the example of FIG. 4. Reference signal 1220 may be sent and obtained over a single tone or subcarrier and orthogonally cover coded according to the OCCs corresponding to the multiple coherent ports of reference signal 1222 in CDM group 1210. For example, gRS 802, 902, 1002, or 1102 in slot n−1 may be transmitted and received over one subcarrier and orthogonally coded to have the same channel response as a multi-port DMRS 408 transmitted and received in the same frequency tone but in a different symbol in slot n, such as illustrated in any of FIGS. 8-11. This gRS 802, 902, 1002, or 1102 may be configured in a last symbol of the PDSCH or PUSCH in slot n−1 or otherwise close to or adjacent to the gap 602, 1216 between time spans 1206, 1218 or slots n−1 and n, such as illustrated in any of FIGS. 8-11. Such placement near gap 602 allows the UE or base station to determine the phase jump 604 across gap 602 from respective phase estimates 606, 608 of the gRS and DMRS even in high Doppler scenarios, so that the UE or base station may compensate for this phase jump when it performs joint channel estimation of the reference signals 1208 and 1222 and thereby accurately decode PDSCH 1212, 1224 or PUSCH 1214, 1226.

At block 1406, the network entity may send, in the second time span, a third reference signal associated with the multiple coherent ports in the CDM group. For example, block 1406 may be performed by reference signal component 1640. Sending the third reference signal may include, for example, transmitting, modulating, and encoding the third reference signal using one or more of the TX processor(s) 316 or controller(s)/processor(s) 375, such as described with respect to BS 310 in FIG. 3. For instance, referring to the Figures, the base station 102/180 or transmitter 1202 may send, and UE 104, 350 or receiver 1204 may obtain, reference signal 1208 in time span 1206. For instance, reference signal 1208 may correspond to DMRS 408 in slot n−1 in FIG. 8. Reference signal 1208 may be sent and obtained over multiple coherent ports in CDM group 1210. For example, DMRS 408 in slot n−1 may be transmitted and received over ports 0 and 1 with different OCCs such as illustrated in FIG. 8, with the different OCCs corresponding to ports 0 and 1 respectively matching the OCCs of the DMRS 408 in slot n.

At block 1408, the network entity may send a PDSCH, or obtain a PUSCH, in the second time span or the first time span based at least in part on the second reference signal and a combination of the first reference signal and the third reference signal. For example, block 1408 may be performed by data component 1642. Sending the PDSCH may include, for example, encoding, modulating, and transmitting the PDSCH using one or more of TX processor(s) 316 or controller(s)/processor(s) 375 such as described with respect to BS 310 in FIG. 3. Obtaining the PUSCH may include, for example, receiving, demodulating, and decoding an encoded and modulated signal including the PUSCH using one or more of RX processor(s) 370 or controller(s)/processor(s) 375 such as described with respect to BS 310 in FIG. 3. For instance, referring to the Figures, the base station 102/180 or transmitter 1202 may send and UE 104, 350 or receiver 1204 may obtain PDSCH 1212, 1224, or the base station 102/180 or transmitter 1202 may obtain and UE 104, 350 or receiver 1204 may send PUSCH 1214, 1226. The PDSCH 1212 or PUSCH 1214 may be sent or obtained in time span 1206, while the PDSCH 1224 or PUSCH 1226 may be sent or obtained in time span 1218. The base station may send PDSCH 1212 or obtain PUSCH 1214 in response to the UE or base station respectively applying noncausal combining of reference signals 1208 and 1222, such as DMRS 408 in slots n−1 and n, while accounting for the phase jump 604 derived using reference signal 1220, such as gRS 802, 902, 1002, or 1102 in slot n−1. Alternatively, the base station may send PDSCH 1224 or obtain PUSCH 1226 in response to the UE or base station respectively applying causal combining of reference signals 1208 and 1222, such as DMRS 408 in slots n−1 and n, while accounting for the phase jump 604 derived using reference signal 1220, such as gRS 802, 902, 1002, or 1102 in slot n−1.

In one example, the second reference signal may be transmitted in a single subcarrier within each of multiple RBs of a plurality of RBs. More particularly, in one example, the multiple RBs may include each Xth RB in the plurality of RBs, where X≥2. For instance, referring to FIG. 9, the base station 102/180, 310 or transmitter 1202 may send, and the UE 104, 350 or receiver 1204 may receive, gRS 902 in the subcarrier corresponding to one of the DMRS 408 tones in one of every X RBs, such as every second RB in this example shown in FIG. 9.

In one example, the second reference signal may be repeated over the multiple coherent ports associated with the first reference signal in the single subcarrier within the each of the multiple RBs. For instance, referring to FIGS. 8 and 9, the base station 102/180, 310 or transmitter 1202 may send, and the UE 104, 350 or receiver 1204 may receive, repetitions of gRS 802, 902 over the ports 0 and 1 from which DMRS 408 is sent in slot n, resulting in the gRS having the same channel response as the corresponding DMRS such as H0,j+H1,j in this example, excluding phase jump 604. The gRS 902 may be sent and received in the subcarrier corresponding to this DMRS 408 in one of every X RBs, such as every other RB in this example.

In one example, the second reference signal may be applied with an orthogonal cover code associated with each of the multiple coherent ports for the first reference signal. For instance, referring to FIGS. 8-10, the base station 102/180, 310 or transmitter 1202 may send, and the UE 104, 350 or receiver 1204 may receive, repetitions of gRS 802, 902, 1002 using the same OCC for which DMRS 408 is coded in slot n, resulting in the gRS having the same channel response as the corresponding DMRS. For instance, if the DMRS sent over ports 0 and 1 in one subcarrier uses an OCC of (+1, −1) such that its channel response is H0,j−H1,j in this example, the gRS may similarly apply that OCC to result in a same channel response of H0,j−H1,j such as illustrated in FIG. 10, excluding phase jump 604. The gRS 902 may be sent and received in the subcarrier corresponding to this DMRS 408 in one of every X RBs, such as every other RB in this example.

In one example, the single subcarriers in each of the multiple RBs may together comprise a subset of a set of subcarriers for the first reference signal. For instance, referring to FIGS. 9 and 10, the base station 102/180, 310 or transmitter 1202 may send, and the UE 104, 350 or receiver 1204 may receive, gRS 902, 1002 in the subcarrier corresponding to one of the DMRS 408 tones in one of every X RBs, such as every second RB in this example shown in FIG. 9. This subcarrier for gRS 902, 1002 may be a subset of the subcarriers used for DMRS 408, such as one of the two subcarriers applied for DMRS 408 in every second RB in FIGS. 9 and 10.

In one example, the subset may include subcarriers where the multiple coherent ports for the first reference signal are each associated with a positive orthogonal cover code. For instance, referring to FIG. 9, the base station 102/180, 310 or transmitter 1202 may send, and the UE 104, 350 or receiver 1204 may receive, gRS 902 in the subcarrier corresponding to one of the DMRS 408 tones in one of every X RBs, such as every second RB in this example shown in FIG. 9. This subcarrier for gRS 902 may be a subset of the subcarriers used for DMRS 408 which is applied with a positive OCC, such as the one of the two subcarriers applied for DMRS 408 in every second RB illustrated in FIG. 9. Here, a positive OCC is one which only includes positive signs, such as (+1, +1) in the example of FIG. 9.

In one example, the subset may include subcarriers where the multiple coherent ports for the first reference signal are each associated with either a positive orthogonal cover code or a negative orthogonal cover code. For instance, referring to FIGS. 9 and 10, the base station 102/180, 310 or transmitter 1202 may send, and the UE 104, 350 or receiver 1204 may receive, gRS 902, 1002 in the subcarrier corresponding to one of the DMRS 408 tones in one of every X RBs, such as every second RB in this example shown in FIG. 9. This subcarrier for gRS 902, 1002 may be a subset of the subcarriers used for DMRS 408 which is applied with a positive OCC or a negative OCC, such as the one of the two subcarriers applied for DMRS 408 in every second RB illustrated in FIG. 9 or FIG. 10. Here, a positive OCC is one which only includes positive signs, such as (+1, +1) in the example of FIG. 9, while a negative OCC is one which includes at least one negative sign, such as (+1, −1) in the example of FIG. 10.

In one example, the second reference signal is transmitted in M subcarriers respectively within each of multiple resource blocks (RBs) of a plurality of RBs, the M subcarriers in each of the multiple RBs together comprise a subset of a set of subcarriers for the first reference signal, M is an orthogonal cover code length for the first reference signal, and the multiple RBs include each 2X^{th} RB in the plurality of RBs, where X≥2. For instance, referring to FIGS. 9 and 10, the base station 102/180, 310 or transmitter 1202 may send, and the UE 104, 350 or receiver 1204 may receive, gRS 902, 1002 in the subcarrier corresponding to M of the DMRS 408 tones in one of every 2X RBs, such as both DMRS tones in every fourth RB in an alternative of the example shown in FIG. 9 where X=2. These M subcarrier for gRS 902, 1002 may be a subset of the subcarriers used in total for DMRS 408, such as half of all subcarriers applied in total for DMRS 408 across all RBs in the alternative example of FIG. 9. In the examples of FIGS. 9 and 10, M may be two such that the DMRS 408 has a length-2 OCC corresponding to ports 0 and 1, although M may be different in other examples.

In various examples, the second reference signal may be transmitted in a single subcarrier within each of a plurality of RBs, the plurality of RBs includes a first set of inconsecutive RBs and a second set of inconsecutive RBs, the single subcarriers in each of the plurality of RBs together comprise a subset of a set of subcarriers for the first reference signal, the subset including subcarriers in the first set of inconsecutive RBs where the multiple coherent ports for the first reference signal are each associated with a positive orthogonal cover code, and the subset including subcarriers in the second set of inconsecutive RBs where the multiple coherent ports for the first reference signal are respectively associated with a negative orthogonal cover code. In one of these examples, the first set of inconsecutive RBs may include even indexed subcarriers for the second reference signal, and the second set of inconsecutive RBs may include odd indexed subcarriers for the second reference signal. In another of these examples, the second reference signal in the first set of inconsecutive RBs may be applied with the positive orthogonal cover code associated with each of the multiple coherent ports for the first reference signal, and the second reference signal in the second set of inconsecutive RBs may be applied with the negative orthogonal cover code respectively associated with the multiple coherent ports for the first reference signal. For instance, referring to FIG. 11, the base station 102/180, 310 or transmitter 1202 may send, and the UE 104, 350 or receiver 1204 may receive, gRS 1102 in a subcarrier corresponding to one of the DMRS 408 tones in each of a plurality of RBs, such as an even-indexed subcarrier and an odd-indexed subcarrier respectively in at least two RBs in the example shown in FIG. 11. This subcarrier for gRS 902, 1002 may be a subset of the subcarriers used for DMRS 408, such as every even subcarrier corresponding to a DMRS tone which is applied with a positive OCC and every odd subcarrier corresponding to a DMRS tone which is applied with a negative OCC, such as illustrated in FIG. 11. The even and odd subcarriers may be alternatingly applied in different RBs such as illustrated in FIG. 11, such that gRS 1102 in one set of inconsecutive RBs including every even RB applies a positive OCC while gRS 1102 in another set of inconsecutive RBs including every odd RB applies a negative OCC, again such as illustrated in FIG. 11. Here, a positive OCC is one which only includes positive signs, such as (+1, +1) in the example of FIG. 11, while a negative OCC is one which includes at least one negative sign, such as (+1, −1) in the example of FIG. 11.

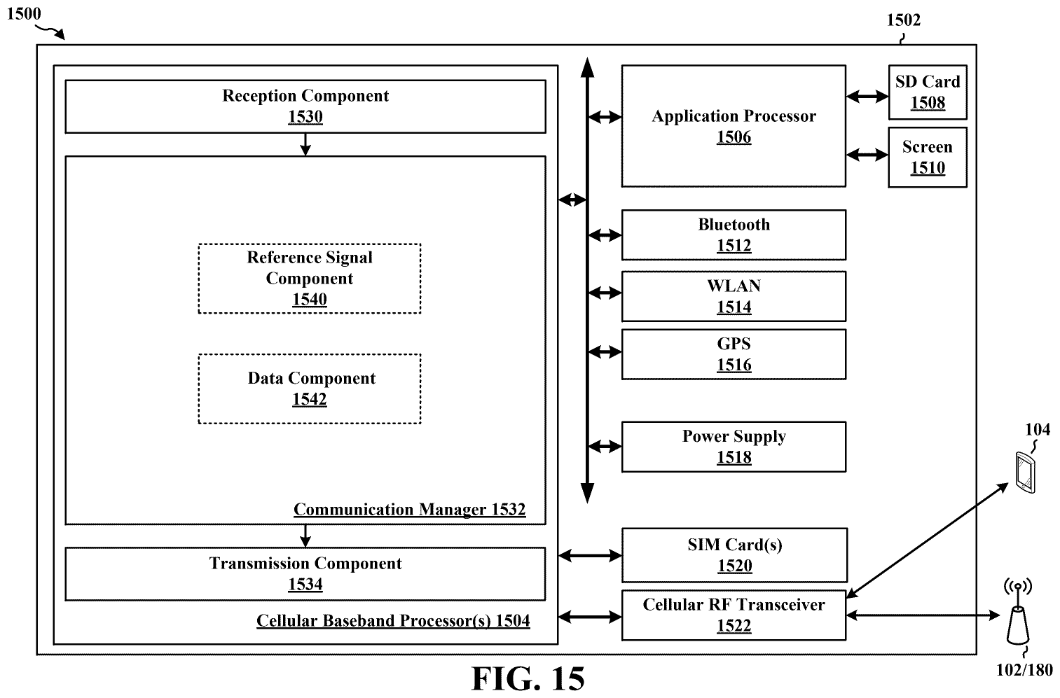

FIG. 15 is a diagram 1500 illustrating an example of a hardware implementation for an apparatus 1502. The apparatus 1502 is a UE and includes one or more cellular baseband processors 1504 (also referred to as a modem) coupled to a cellular RF transceiver 1522 and one or more subscriber identity modules (SIM) cards 1520, an application processor 1506 coupled to a secure digital (SD) card 1508 and a screen 1510, a Bluetooth module 1512, a wireless local area network (WLAN) module 1514, a Global Positioning System (GPS) module 1516, and a power supply 1518. The one or more cellular baseband processors 1504 communicate through the cellular RF transceiver 1522 with the BS 102/180/disaggregated base station 181. For example, the cellular RF transceiver 1522 may correspond to or include the transmitters 354TX, receivers 354RX, and antennas 352 of UE 350.

The one or more cellular baseband processors 1504 may each include a computer-readable medium/one or more memories. The computer-readable medium/one or more memories may be non-transitory. The one or more cellular baseband processors 1504 are responsible for general processing, including the execution of software stored on the computer-readable medium/one or more memories individually or in combination. The software, when executed by the one or more cellular baseband processors 1504, causes the one or more cellular baseband processors 1504 to, individually or in combination, perform the various functions described supra. The computer-readable medium/one or more memories may also be used individually or in combination for storing data that is manipulated by the one or more cellular baseband processors 1504 when executing software. The one or more cellular baseband processors 1504 individually or in combination further include a reception component 1530, a communication manager 1532, and a transmission component 1534. The communication manager 1532 includes the one or more illustrated components. The components within the communication manager 1532 may be stored in the computer-readable medium/one or more memories and/or configured as hardware within the one or more cellular baseband processors 1504. The one or more cellular baseband processors 1504 may be components of the UE 350 and may individually or in combination include the one or more memories 360 and/or at least one of the one or more TX processors 368, at least one of the one or more RX processors 356, and at least one of the one or more controllers/processors 359. For example, the reception component 1530 may include at least the one or more RX processors 356, the transmission component 1534 may include at least the one or more TX processors 368, and the communication manager 1532 may include at least the one or more controllers/processors 359. In one configuration, the apparatus 1502 may be a modem chip and include just the one or more baseband processors 1504, and in another configuration, the apparatus 1502 may be the entire UE (e.g., see 350 of FIG. 3) and include the aforediscussed additional modules of the apparatus 1502.

The communication manager 1532 includes a reference signal component 1540 that is configured to, for example via reception component 1530, obtain in a first time span, a first reference signal associated with multiple coherent ports in a CDM group, obtain in a second time span prior to the first time span, a second reference signal associated with at least one tone and code division multiplexed based on the multiple coherent ports for the first reference signal, the second reference signal being configured for compensation of a phase change across a gap between the second time span and the first time span, the first time span and the second time span respectively corresponding to different SLIVs or different slots of a same SLIV, and obtain, in the second time span, a third reference signal associated with the multiple coherent ports in the CDM group, such as described in connection with blocks 1302, 1304, and 1306 respectively. The communication manager 1532 may further include a data component 1542 that is configured to, for example via reception component 1530 or transmission component 1534 respectively, obtain a PDSCH or send a PUSCH in the second time span or the first time span based at least in part on the second reference signal and a combination of the first reference signal and the third reference signal, such as described in connection with block 1308.

The apparatus may include additional components that perform each of the blocks of the algorithm in the aforementioned flowchart of FIG. 13. As such, each block in the aforementioned flowchart of FIG. 13 may be performed by a component and the apparatus may include one or more of those components. The components may be one or more hardware components specifically configured to carry out the stated processes/algorithm, implemented by one or more processors individually or in combination configured to perform the stated processes/algorithm, stored within a computer-readable medium for implementation by one or more processors, or some combination thereof.

In one configuration, the apparatus 1502, and in particular the one or more cellular baseband processors 1504, includes means for obtaining, in a first time span, a first reference signal associated with multiple coherent ports in a CDM group; in a second time span prior to the first time span, a second reference signal associated with at least one tone and code division multiplexed based on the multiple coherent ports for the first reference signal, the second reference signal being configured for compensation of a phase change across a gap between the second time span and the first time span, the first time span and the second time span respectively corresponding to different SLIVs or different slots of a same SLIV; and in the second time span, a third reference signal associated with the multiple coherent ports in the CDM group. The apparatus 1502, and in particular the one or more cellular baseband processors 1504, further includes means for sending a PUSCH, or the means for obtaining may further be configured to obtain a PDSCH, in the second time span or the first time span based at least in part on the second reference signal and a combination of the first reference signal and the third reference signal.

The aforementioned means may be one or more of the aforementioned components of the apparatus 1502 configured to perform the functions recited by the aforementioned means. As described supra, the apparatus 1502 may include the one or more TX Processors 368, the one or more RX Processors 356, and the one or more controllers/processors 359. As such, in one configuration, the aforementioned means may be at least one of the one or more TX Processors 368, at least one of the one or more RX Processors 356, or at least one of the one or more controllers/processors 359, individually or in any combination configured to perform the functions recited by the aforementioned means.

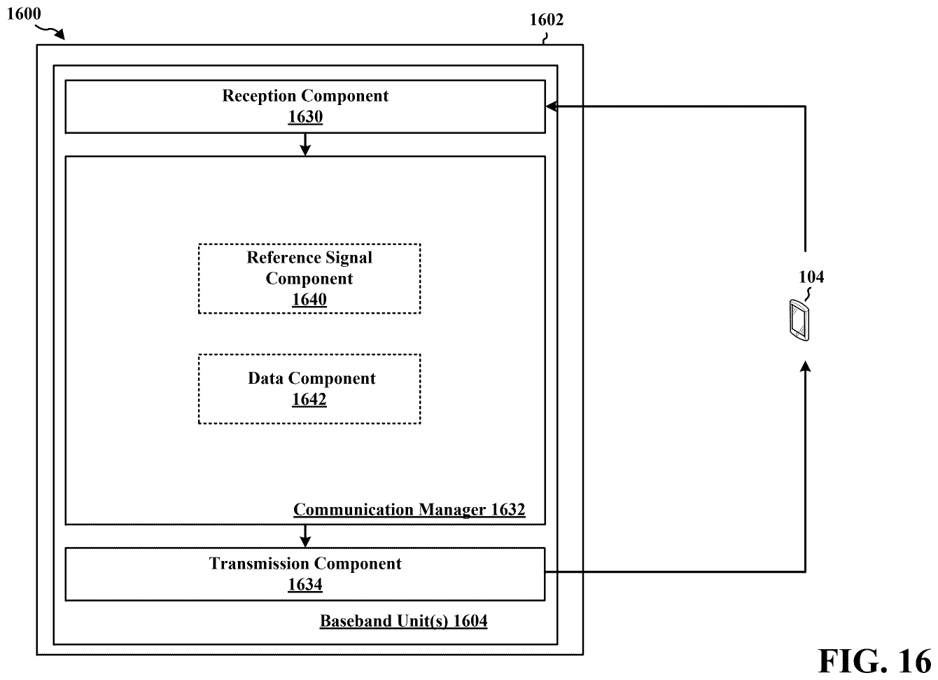

FIG. 16 is a diagram 1600 illustrating an example of a hardware implementation for an apparatus 1602. The apparatus 1602 is a network entity such as a base station and includes one or more baseband units 1604. The one or more baseband units 1604 communicate through a cellular RF transceiver with the UE 104. For example, the cellular RF transceiver may correspond to or include the transmitters 318TX, receivers 318RX, and antennas 320 of base station 310.

The one or more baseband units 1604 may each include a computer-readable medium/one or more memories. The computer-readable medium/one or more memories may be non-transitory. The one or more baseband units 1604 are responsible for general processing, including the execution of software stored on the computer-readable medium/one or more memories individually or in combination. The software, when executed by the one or more baseband units 1604, causes the one or more baseband units 1604 to, individually or in combination, perform the various functions described supra. The computer-readable medium/one or more memories may also be used individually or in combination for storing data that is manipulated by the one or more baseband units 1604 when executing software. The one or more baseband units 1604 individually or in combination further include a reception component 1630, a communication manager 1632, and a transmission component 1634. The communication manager 1632 includes the one or more illustrated components. The components within the communication manager 1632 may be stored in the computer-readable medium/one or more memories and/or configured as hardware within the one or more baseband units 1604. The one or more baseband units 1604 may be components of the BS 310 and may individually or in combination include the one or more memories 376 and/or at least one of the one or more TX processors 316, at least one of the one or more RX processors 370, and at least one of the one or more controllers/processors 375. For example, the reception component 1630 may include at least the one or more RX processors 370, the transmission component 1634 may include at least the one or more TX processors 316, and the communication manager 1632 may include at least the one or more controllers/processors 375.

The communication manager 1632 includes a reference signal component 1640 that is configured to, for example via transmission component 1634, send in a first time span, a first reference signal associated with multiple coherent ports in a CDM group, send in a second time span prior to the first time span, a second reference signal associated with at least one tone and code division multiplexed based on the multiple coherent ports for the first reference signal, the second reference signal being configured for compensation of a phase change across a gap between the second time span and the first time span, the first time span and the second time span respectively corresponding to different SLIVs or different slots of a same SLIV, and send, in the second time span, a third reference signal associated with the multiple coherent ports in the CDM group, such as described in connection with blocks 1402, 1404, and 1406 respectively. The communication manager 1632 may further include a data component 1642 that is configured to, for example via transmission component 1634 or reception component 1630 respectively, send a PDSCH or obtain a PUSCH in the second time span or the first time span based at least in part on the second reference signal and a combination of the first reference signal and the third reference signal, such as described in connection with block 1408.

The apparatus may include additional components that perform each of the blocks of the algorithm in the aforementioned flowchart of FIG. 14. As such, each block in the aforementioned flowchart of FIG. 14 may be performed by a component and the apparatus may include one or more of those components. The components may be one or more hardware components specifically configured to carry out the stated processes/algorithm, implemented by one or more processors individually or in combination configured to perform the stated processes/algorithm, stored within a computer-readable medium for implementation by one or more processors, or some combination thereof.

In one configuration, the apparatus 1602, and in particular the one or more baseband unit(s) 1604, includes means for sending, in a first time span, a first reference signal associated with multiple coherent ports in a CDM group; in a second time span prior to the first time span, a second reference signal associated with at least one tone and code division multiplexed based on the multiple coherent ports for the first reference signal, the second reference signal being configured for compensation of a phase change across a gap between the second time span and the first time span, the first time span and the second time span respectively corresponding to different SLIVs or different slots of a same SLIV; and in the second time span, a third reference signal associated with the multiple coherent ports in the CDM group. The apparatus 1602, and in particular the one or more baseband unit(s) 1604, further includes means for obtaining a PUSCH, or the means for sending may further be configured to send a PDSCH, in the second time span or the first time span based at least in part on the second reference signal and a combination of the first reference signal and the third reference signal.

The aforementioned means may be one or more of the aforementioned components of the apparatus 1602 configured to perform the functions recited by the aforementioned means. As described supra, the apparatus 1602 may include the one or more TX Processors 316, the one or more RX Processors 370, and the one or more controllers/processors 375. As such, in one configuration, the aforementioned means may be at least one of the one or more TX Processors 316, at least one of the one or more RX Processors 370, or at least one of the one or more controllers/processors 375, individually or in any combination configured to perform the functions recited by the aforementioned means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, a processor, at least one processor, and/or one or more processors, individually or in combination, configured to perform or operable for performing a plurality of actions (such as the functions described supra) is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

Similarly as used herein, a memory, at least one memory, a computer-readable medium, and/or one or more memories, individually or in combination, configured to store or having stored thereon instructions executable by one or more processors for performing a plurality of actions (such as the functions described supra) is meant to include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, a computer-readable medium, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, a second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processors may in combination execute the respective subset of instruction to accomplish performing actions X, Y, and Z. Alternatively, a single processor may execute the instructions stored on a single memory, or distributed across multiple memories, to accomplish performing actions X, Y, and Z.

The following examples are illustrative only and may be combined with aspects of other embodiments or teachings described herein, without limitation.

Clause 1. An apparatus for wireless communication, comprising: one or more memories; and one or more processors each communicatively coupled with at least one of the one or more memories, the one or more processors, individually or in any combination, operable to cause the apparatus to: obtain, in a first time span, a first reference signal associated with multiple coherent ports in a CDM group; obtain, in a second time span prior to the first time span, a second reference signal associated with at least one tone and code division multiplexed based on the multiple coherent ports for the first reference signal, the second reference signal being configured for compensation of a phase change across a gap between the second time span and the first time span, the first time span and the second time span respectively corresponding to different SLIVs or different slots of a same SLIV; obtain, in the second time span, a third reference signal associated with the multiple coherent ports in the CDM group; and obtain a PDSCH, or send a PUSCH, in the second time span or the first time span based at least in part on the second reference signal and a combination of the first reference signal and the third reference signal.

Clause 2. The apparatus of clause 1, wherein the second reference signal is received in a single subcarrier within each of multiple RBs of a plurality of RBs.

Clause 3. The apparatus of clause 2, wherein the second reference signal is repeated over the multiple coherent ports associated with the first reference signal in the single subcarrier within the each of the multiple RBs.

Clause 4. The apparatus of clause 2 or clause 3, wherein the second reference signal is applied with an orthogonal cover code associated with each of the multiple coherent ports for the first reference signal.

Clause 5. The apparatus of any of clauses 2 to 4, wherein the multiple RBs include each Xth RB in the plurality of RBs, wherein X≥2.

Clause 6. The apparatus of any of clauses 2 to 5, wherein the single subcarriers in each of the multiple RBs together comprise a subset of a set of subcarriers for the first reference signal.

Clause 7. The apparatus of clause 6, wherein the subset includes subcarriers where the multiple coherent ports for the first reference signal are each associated with a positive orthogonal cover code.

Clause 8. The apparatus of clause 6, wherein the subset includes subcarriers where the multiple coherent ports for the first reference signal are each associated with either a positive orthogonal cover code or a negative orthogonal cover code.

Clause 9. The apparatus of any of clause 1, wherein the second reference signal is received in M subcarriers respectively within each of multiple RBs of a plurality of RBs, the M subcarriers in each of the multiple RBs together comprise a subset of a set of subcarriers for the first reference signal, M is an orthogonal cover code length for the first reference signal, and the multiple RBs include each 2Xth RB in the plurality of RBs, wherein X≥2.

Clause 10. The apparatus of clause 1, wherein the second reference signal is received in a single subcarrier within each of a plurality of RBs, the plurality of RBs includes a first set of inconsecutive RBs and a second set of inconsecutive RBs, the single subcarriers in each of the plurality of RBs together comprise a subset of a set of subcarriers for the first reference signal, the subset including subcarriers in the first set of inconsecutive RBs where the multiple coherent ports for the first reference signal are each associated with a positive orthogonal cover code, and the subset including subcarriers in the second set of inconsecutive RBs where the multiple coherent ports for the first reference signal are respectively associated with a negative orthogonal cover code.

Clause 11. The apparatus of clause 10, wherein the first set of inconsecutive RBs include even indexed subcarriers for the second reference signal, and the second set of inconsecutive RBs include odd indexed subcarriers for the second reference signal.

Clause 12. The apparatus of clause 10 or clause 11, wherein the second reference signal in the first set of inconsecutive RBs is applied with the positive orthogonal cover code associated with each of the multiple coherent ports for the first reference signal, and wherein the second reference signal in the second set of inconsecutive RBs is applied with the negative orthogonal cover code respectively associated with the multiple coherent ports for the first reference signal.

Clause 13. A method of wireless communication performable at a user equipment (UE), comprising: obtaining, in a first time span, a first reference signal associated with multiple coherent ports in a CDM group; obtaining, in a second time span prior to the first time span, a second reference signal associated with at least one tone and code division multiplexed based on the multiple coherent ports for the first reference signal, the second reference signal being configured for compensation of a phase change across a gap between the second time span and the first time span, the first time span and the second time span respectively corresponding to different SLIVs or different slots of a same SLIV; obtaining, in the second time span, a third reference signal associated with the multiple coherent ports in the CDM group; and obtaining a PDSCH, or sending a PUSCH, in the second time span or the first time span based at least in part on the second reference signal and a combination of the first reference signal and the third reference signal.

Clause 14. The method of clause 13, wherein the second reference signal is received in a single subcarrier within each of multiple RBs of a plurality of RBs, the second reference signal is repeated over the multiple coherent ports associated with the first reference signal in the single subcarrier within the each of the multiple RBs, the single subcarriers in each of the multiple RBs together comprise a subset of a set of subcarriers for the first reference signal, and the multiple RBs include each Xth RB in the plurality of RBs, wherein X≥2.

Clause 15. The method of clause 13, wherein the second reference signal is received in a single subcarrier within each of a plurality of RBs, the plurality of RBs includes a first set of inconsecutive RBs and a second set of inconsecutive RBs, the single subcarriers in each of the plurality of RBs together comprise a subset of a set of subcarriers for the first reference signal, the subset including subcarriers in the first set of inconsecutive RBs where the multiple coherent ports for the first reference signal are each associated with a positive orthogonal cover code, and the subset including subcarriers in the second set of inconsecutive RBs where the multiple coherent ports for the first reference signal are respectively associated with a negative orthogonal cover code.

Clause 16. An apparatus for wireless communication, comprising: one or more memories; and one or more processors each communicatively coupled with at least one of the one or more memories, the one or more processors, individually or in any combination, operable to cause the apparatus to: send, in a first time span, a first reference signal associated with multiple coherent ports in a CDM group; send, in a second time span prior to the first time span, a second reference signal associated with at least one tone and code division multiplexed based on the multiple coherent ports for the first reference signal, the second reference signal being configured for compensation of a phase change across a gap between the second time span and the first time span, the first time span and the second time span respectively corresponding to different SLIVs or different slots of a same SLIV; send, in the second time span, a third reference signal associated with the multiple coherent ports in the CDM group; and send a PDSCH, or obtain a PUSCH, in the second time span or the first time span based at least in part on the second reference signal and a combination of the first reference signal and the third reference signal.

Clause 17. The apparatus of clause 16, wherein the second reference signal is transmitted in a single subcarrier within each of multiple RBs of a plurality of RBs.

Clause 18. The apparatus of clause 17, wherein the second reference signal is repeated over the multiple coherent ports associated with the first reference signal in the single subcarrier within the each of the multiple RBs.

Clause 19. The apparatus of clause 17 or clause 18, wherein the second reference signal is applied with an orthogonal cover code associated with each of the multiple coherent ports for the first reference signal.

Clause 20. The apparatus of any of clauses 17 to 19, wherein the multiple RBs include each Xth RB in the plurality of RBs, wherein X≥2.

Clause 21. The apparatus of any of clauses 17 to 20, wherein the single subcarriers in each of the multiple RBs together comprise a subset of a set of subcarriers for the first reference signal.

Clause 22. The apparatus of clause 21, wherein the subset includes subcarriers where the multiple coherent ports for the first reference signal are each associated with a positive orthogonal cover code.

Clause 23. The apparatus of clause 21, wherein the subset includes subcarriers where the multiple coherent ports for the first reference signal are each associated with either a positive orthogonal cover code or a negative orthogonal cover code.

Clause 24. The apparatus of clause 16, wherein the second reference signal is transmitted in M subcarriers respectively within each of multiple RBs of a plurality of RBs, the M subcarriers in each of the multiple RBs together comprise a subset of a set of subcarriers for the first reference signal, M is an orthogonal cover code length for the first reference signal, and the multiple RBs include each 2Xth RB in the plurality of RBs, wherein X≥2.

Clause 25. The apparatus of clause 16, wherein the second reference signal is transmitted in a single subcarrier within each of a plurality of RBs, the plurality of RBs includes a first set of inconsecutive RBs and a second set of inconsecutive RBs, the single subcarriers in each of the plurality of RBs together comprise a subset of a set of subcarriers for the first reference signal, the subset including subcarriers in the first set of inconsecutive RBs where the multiple coherent ports for the first reference signal are each associated with a positive orthogonal cover code, and the subset including subcarriers in the second set of inconsecutive RBs where the multiple coherent ports for the first reference signal are respectively associated with a negative orthogonal cover code.

Clause 26. The apparatus of clause 25, wherein the first set of inconsecutive RBs include even indexed subcarriers for the second reference signal, and the second set of inconsecutive RBs include odd indexed subcarriers for the second reference signal.

Clause 27. The apparatus of clause 25 or clause 26, wherein the second reference signal in the first set of inconsecutive RBs is applied with the positive orthogonal cover code associated with each of the multiple coherent ports for the first reference signal, and wherein the second reference signal in the second set of inconsecutive RBs is applied with the negative orthogonal cover code respectively associated with the multiple coherent ports for the first reference signal.

Clause 28. A method of wireless communication performable at a network entity, comprising: sending, in a first time span, a first reference signal associated with multiple coherent ports in a CDM group; sending, in a second time span prior to the first time span, a second reference signal associated with at least one tone and code division multiplexed based on the multiple coherent ports for the first reference signal, the second reference signal being configured for compensation of a phase change across a gap between the second time span and the first time span; sending, in the second time span, a third reference signal associated with the multiple coherent ports in the CDM group, the first time span and the second time span respectively corresponding to different SLIVs or different slots of a same SLIV; and sending a PDSCH, or obtaining a PUSCH, in the second time span or the first time span based at least in part on the second reference signal and a combination of the first reference signal and the third reference signal.

Clause 29. The method of clause 28, wherein the second reference signal is transmitted in a single subcarrier within each of multiple RBs of a plurality of RBs, the second reference signal is repeated over the multiple coherent ports associated with the first reference signal in the single subcarrier within the each of the multiple RBs, the single subcarriers in each of the multiple RBs together comprise a subset of a set of subcarriers for the first reference signal, and the multiple RBs include each Xth RB in the plurality of RBs, wherein X≥2.

Clause 30. The method of clause 28, wherein the second reference signal is transmitted in a single subcarrier within each of a plurality of RBs, the plurality of RBs includes a first set of inconsecutive RBs and a second set of inconsecutive RBs, the single subcarriers in each of the plurality of RBs together comprise a subset of a set of subcarriers for the first reference signal, the subset including subcarriers in the first set of inconsecutive RBs where the multiple coherent ports for the first reference signal are each associated with a positive orthogonal cover code, and the subset including subcarriers in the second set of inconsecutive RBs where the multiple coherent ports for the first reference signal are respectively associated with a negative orthogonal cover code.

What is claimed is:

1. An apparatus for wireless communication, comprising:
one or more memories; and
one or more processors each communicatively coupled with at least one of the one or more memories, the one or more processors, individually or in any combination, operable to cause the apparatus to:
obtain, in a first time span, a first reference signal associated with multiple coherent ports in a code division multiplexing (CDM) group;
obtain, in a second time span prior to the first time span, a second reference signal associated with at least one tone and code division multiplexed based on the multiple coherent ports for the first reference signal, the second reference signal being configured for compensation of a phase change across a gap between the second time span and the first time span, the first time span and the second time span respectively corresponding to different start and length indicator values (SLIVs) or different slots of a same SLIV;
obtain, in the second time span, a third reference signal associated with the multiple coherent ports in the CDM group; and
obtain a physical downlink shared channel (PDSCH), or send a physical uplink shared channel (PUSCH), in the second time span or the first time span based at least in part on the second reference signal and a combination of the first reference signal and the third reference signal.

2. The apparatus of claim 1, wherein the second reference signal is received in a single subcarrier within each of multiple resource blocks (RBs) of a plurality of RBs.

3. The apparatus of claim 2, wherein the second reference signal is repeated over the multiple coherent ports associated with the first reference signal in the single subcarrier within the each of the multiple RBs.

4. The apparatus of claim 2, wherein the second reference signal is applied with an orthogonal cover code associated with each of the multiple coherent ports for the first reference signal.

5. The apparatus of claim 2, wherein the multiple RBs include each X^{th} RB in the plurality of RBs, wherein X≥2.

6. The apparatus of claim 2, wherein the single subcarriers in each of the multiple RBs together comprise a subset of a set of subcarriers for the first reference signal.

7. The apparatus of claim 6, wherein the subset includes subcarriers where the multiple coherent ports for the first reference signal are each associated with a positive orthogonal cover code.

8. The apparatus of claim 6, wherein the subset includes subcarriers where the multiple coherent ports for the first reference signal are each associated with either a positive orthogonal cover code or a negative orthogonal cover code.

9. The apparatus of claim 1, wherein the second reference signal is received in M subcarriers respectively within each of multiple resource blocks (RBs) of a plurality of RBs, the M subcarriers in each of the multiple RBs together comprise a subset of a set of subcarriers for the first reference signal, M is an orthogonal cover code length for the first reference signal, and the multiple RBs include each 2X^{th} RB in the plurality of RBs, wherein X≥2.

10. The apparatus of claim 1, wherein the second reference signal is received in a single subcarrier within each of a plurality of RBs, the plurality of RBs includes a first set of inconsecutive RBs and a second set of inconsecutive RBs, the single subcarriers in each of the plurality of RBs together comprise a subset of a set of subcarriers for the first reference signal, the subset including subcarriers in the first set of inconsecutive RBs where the multiple coherent ports for the first reference signal are each associated with a positive orthogonal cover code, and the subset including subcarriers in the second set of inconsecutive RBs where the multiple coherent ports for the first reference signal are respectively associated with a negative orthogonal cover code.

11. The apparatus of claim 10, wherein the first set of inconsecutive RBs include even indexed subcarriers for the second reference signal, and the second set of inconsecutive RBs include odd indexed subcarriers for the second reference signal.

12. The apparatus of claim 10, wherein the second reference signal in the first set of inconsecutive RBs is applied with the positive orthogonal cover code associated with each of the multiple coherent ports for the first reference signal, and wherein the second reference signal in the second set of inconsecutive RBs is applied with the negative orthogonal cover code respectively associated with the multiple coherent ports for the first reference signal.

13. A method of wireless communication performable at a user equipment (UE), comprising:
obtaining, in a first time span, a first reference signal associated with multiple coherent ports in a code division multiplexing (CDM) group;
obtaining, in a second time span prior to the first time span, a second reference signal associated with at least one tone and code division multiplexed based on the multiple coherent ports for the first reference signal, the second reference signal being configured for compensation of a phase change across a gap between the second time span and the first time span, the first time span and the second time span respectively corresponding to different start and length indicator values (SLIVs) or different slots of a same SLIV;
obtaining, in the second time span, a third reference signal associated with the multiple coherent ports in the CDM group; and
obtaining a physical downlink shared channel (PDSCH), or sending a physical uplink shared channel (PUSCH), in the second time span or the first time span based at least in part on the second reference signal and a combination of the first reference signal and the third reference signal.

14. The method of claim 13, wherein the second reference signal is received in a single subcarrier within each of multiple resource blocks (RBs) of a plurality of RBs, the second reference signal is repeated over the multiple coherent ports associated with the first reference signal in the single subcarrier within the each of the multiple RBs, the single subcarriers in each of the multiple RBs together comprise a subset of a set of subcarriers for the first reference signal, and the multiple RBs include each X^{th} RB in the plurality of RBs, wherein X≥2.

15. The method of claim 13, wherein the second reference signal is received in a single subcarrier within each of a plurality of RBs, the plurality of RBs includes a first set of inconsecutive RBs and a second set of inconsecutive RBs, the single subcarriers in each of the plurality of RBs together comprise a subset of a set of subcarriers for the first reference signal, the subset including subcarriers in the first set of inconsecutive RBs where the multiple coherent ports for the first reference signal are each associated with a positive orthogonal cover code, and the subset including subcarriers in the second set of inconsecutive RBs where the multiple coherent ports for the first reference signal are respectively associated with a negative orthogonal cover code.

16. An apparatus for wireless communication, comprising:
one or more memories; and
one or more processors each communicatively coupled with at least one of the one or more memories, the one or more processors, individually or in any combination, operable to cause the apparatus to:
send, in a first time span, a first reference signal associated with multiple coherent ports in a code division multiplexing (CDM) group;
send, in a second time span prior to the first time span, a second reference signal associated with at least one tone and code division multiplexed based on the multiple coherent ports for the first reference signal, the second reference signal being configured for compensation of a phase change across a gap between the second time span and the first time span, the first time span and the second time span respectively corresponding to different start and length indicator values (SLIVs) or different slots of a same SLIV;
send, in the second time span, a third reference signal associated with the multiple coherent ports in the CDM group; and
send a physical downlink shared channel (PDSCH), or obtain a physical uplink shared channel (PUSCH), in the second time span or the first time span based at least in part on the second reference signal and a combination of the first reference signal and the third reference signal.

17. The apparatus of claim 16, wherein the second reference signal is transmitted in a single subcarrier within each of multiple resource blocks (RBs) of a plurality of RBs.

18. The apparatus of claim 17, wherein the second reference signal is repeated over the multiple coherent ports associated with the first reference signal in the single subcarrier within the each of the multiple RBs.

19. The apparatus of claim 17, wherein the second reference signal is applied with an orthogonal cover code associated with each of the multiple coherent ports for the first reference signal.

20. The apparatus of claim 17, wherein the multiple RBs include each X^{th} RB in the plurality of RBs, wherein X≥2.

21. The apparatus of claim 17, wherein the single subcarriers in each of the multiple RBs together comprise a subset of a set of subcarriers for the first reference signal.

22. The apparatus of claim 21, wherein the subset includes subcarriers where the multiple coherent ports for the first reference signal are each associated with a positive orthogonal cover code.

23. The apparatus of claim 21, wherein the subset includes subcarriers where the multiple coherent ports for the first reference signal are each associated with either a positive orthogonal cover code or a negative orthogonal cover code.

24. The apparatus of claim 16, wherein the second reference signal is transmitted in M subcarriers respectively within each of multiple resource blocks (RBs) of a plurality of RBs, the M subcarriers in each of the multiple RBs together comprise a subset of a set of subcarriers for the first reference signal, M is an orthogonal cover code length for the first reference signal, and the multiple RBs include each 2X^{th} RB in the plurality of RBs, wherein X≥2.

25. The apparatus of claim 16, wherein the second reference signal is transmitted in a single subcarrier within each of a plurality of RBs, the plurality of RBs includes a first set of inconsecutive RBs and a second set of inconsecutive RBs, the single subcarriers in each of the plurality of RBs together comprise a subset of a set of subcarriers for the first reference signal, the subset including subcarriers in the first set of inconsecutive RBs where the multiple coherent ports for the first reference signal are each associated with a positive orthogonal cover code, and the subset including subcarriers in the second set of inconsecutive RBs where the multiple coherent ports for the first reference signal are respectively associated with a negative orthogonal cover code.

26. The apparatus of claim 25, wherein the first set of inconsecutive RBs include even indexed subcarriers for the second reference signal, and the second set of inconsecutive RBs include odd indexed subcarriers for the second reference signal.

27. The apparatus of claim 25, wherein the second reference signal in the first set of inconsecutive RBs is applied with the positive orthogonal cover code associated with each of the multiple coherent ports for the first reference signal, and wherein the second reference signal in the second set of inconsecutive RBs is applied with the negative orthogonal cover code respectively associated with the multiple coherent ports for the first reference signal.

28. A method of wireless communication performable at a network entity, comprising:
sending, in a first time span, a first reference signal associated with multiple coherent ports in a code division multiplexing (CDM) group;
sending, in a second time span prior to the first time span, a second reference signal associated with at least one tone and code division multiplexed based on the multiple coherent ports for the first reference signal, the second reference signal being configured for compensation of a phase change across a gap between the second time span and the first time span, the first time span and the second time span respectively corresponding to different start and length indicator values (SLIVs) or different slots of a same SLIV;
sending, in the second time span, a third reference signal associated with the multiple coherent ports in the CDM group; and
sending a physical downlink shared channel (PDSCH), or obtaining a physical uplink shared channel (PUSCH), in the second time span or the first time span based at least in part on the second reference signal and a combination of the first reference signal and the third reference signal.

29. The method of claim 28, wherein the second reference signal is transmitted in a single subcarrier within each of multiple resource blocks (RBs) of a plurality of RBs, the second reference signal is repeated over the multiple coherent ports associated with the first reference signal in the single subcarrier within the each of the multiple RBs, the single subcarriers in each of the multiple RBs together comprise a subset of a set of subcarriers for the first reference signal, and the multiple RBs include each X^{th} RB in the plurality of RBs, wherein X≥2.

30. The method of claim 28, wherein the second reference signal is transmitted in a single subcarrier within each of a plurality of RBs, the plurality of RBs includes a first set of inconsecutive RBs and a second set of inconsecutive RBs, the single subcarriers in each of the plurality of RBs together comprise a subset of a set of subcarriers for the first reference signal, the subset including subcarriers in the first set of inconsecutive RBs where the multiple coherent ports for the first reference signal are each associated with a positive orthogonal cover code, and the subset including subcarriers in the second set of inconsecutive RBs where the multiple coherent ports for the first reference signal are respectively associated with a negative orthogonal cover code.
